(19) United States
(12) Patent Application Publication
(10) Pub. No.: US 2026/0292526 A1
(43) Pub. Date: Sep. 24, 2026

(54) CONSISTENCY BETWEEN MODEL TRAINING AND USAGE FOR UPLINK CONTROL CHANNEL DATA ENCODING

(71) Applicant: QUALCOMM Incorporated, San Diego, CA (US)

(72) Inventors: Rajeev KUMAR, San Diego, CA (US); Akash Sandeep DOSHI, San Diego, CA (US); Taesang YOO, San Diego, CA (US); June NAMGOONG, San Diego, CA (US)

(21) Appl. No.: 19/088,852

(22) Filed: Mar. 24, 2025

(51) Int. Cl. H04W 16/22; H04W 72/21

(52) U.S. Cl. CPC H04W 16/22; H04W 72/21

(57) ABSTRACT

Certain aspects of the present disclosure provide techniques for wireless communications. An example method includes receiving, from a network entity, information indicating a set of criteria for training or using a model associated with encoding uplink control channel data, wherein the set of criteria includes a criterion associated with an uplink control channel data distribution; and performing one or more operations associated with training or using the model based at least in part on a determination that at least one criterion, of the set of criteria, is satisfied, wherein the at least one criterion includes the criterion associated with the uplink control channel data distribution.

### Field of the Disclosure

Aspects of the present disclosure relate to wireless communications, and more particularly, to techniques for consistency between model training and usage for uplink control channel data encoding.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Technical problems with respect to the use of models for encoding and decoding of uplink control channel data include ensuring consistency between model training and usage. For example, consistency between model training and usage may ensure that that a given model for encoding uplink control channel data is used in scenarios that are sufficiently similar to those in which the model is trained (e.g., so as to provide stable, reliable, and predictable outputs). To provide consistency, it may be desirable for a network to control scenarios in which a UE is permitted to train or use a model for encoding uplink control channel data. For example, it may be desirable for a network to permit a UE to use a model for encoding uplink control channel data for data distributions of the uplink control channel that are similar to those based on which the model is trained. Therefore, it is also desirable to control the scenarios in which the UE is permitted to train the model. Such control is desirable to, for example, select or prioritize the training and usage of such a model to scenarios in which model performance is known to achieve a desired outcome, such as increased reliability or improved power efficiency.

Aspects described herein may overcome the aforementioned technical problems, for example, by enabling consistency between model training and usage for uplink control channel data encoding. In some aspects, the techniques for consistency between model training and usage for uplink control channel data encoding described herein may enable improved wireless communications performance, such as improved reliability with respect to uplink control channel communications, reduced complexity at a network entity, and/or improved power efficiency with respect to transmission of uplink control channel data. The improved reliability, reduced complexity at the network entity, and the improved power efficiency may be attributable to the techniques and apparatuses described herein, for example, due to the network control of scenarios in which a UE is permitted to train or use a model for encoding uplink control channel data such that consistency between model training and usage is achieved.

Certain aspects provide a method of wireless communications by a user equipment (UE). The method includes receiving, from a network entity, information indicating a set of criteria for training or using a model associated with encoding uplink control channel data, wherein the set of criteria includes a criterion associated with an uplink control channel data distribution; and performing one or more operations associated with training or using the model based at least in part on a determination that at least one criterion, of the set of criteria, is satisfied, wherein the at least one criterion includes the criterion associated with the uplink control channel data distribution.

Certain aspects provide a method of wireless communications by a network entity. The method includes transmitting, to a UE, information indicating a set of criteria for training or using a model associated with encoding uplink control channel data, wherein the set of criteria includes a criterion associated with an uplink control channel data distribution; receiving an indication that at least one criterion of the set of criteria is satisfied, wherein the at least one criterion includes the criterion associated with the uplink control channel data distribution; and transmitting an inference configuration that includes a set of parameter values associated with the model.

Certain aspects provide a method of wireless communications by a network entity. The method includes obtaining an uplink control channel data distribution dataset associated with one or more UEs, wherein: the uplink control channel data distribution dataset includes a plurality of uplink control channel data distribution values, and an uplink control channel data distribution value of the plurality of uplink control channel data distribution values is associated with one or more conditions; and transmitting, to the UE, an expected uplink control channel data distribution value for the UE or a configuration associated with the expected uplink control channel data distribution value for the UE, wherein the expected uplink control channel data distribution value is based at least in part on the uplink control channel data distribution dataset and a set of current conditions associated with the UE.

Certain aspects provide a method of wireless communications by a UE. The method includes receiving an uplink control channel data distribution value reporting configuration; and transmitting, in accordance with the uplink control channel data distribution value reporting configuration, a communication indicating an actual uplink control channel data distribution value associated with the UE, wherein the communication indicates one or more conditions associated with the actual uplink control channel data distribution value.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 depicts an example artificial intelligence (AI) architecture that may be used for AI-enhanced wireless communications.

FIG. 6 depicts an example AI architecture of a first wireless device that is in communication with a second wireless device.

FIG. 7 depicts an example artificial neural network.

FIG. 8 depicts an example associated with consistency between model training and usage for uplink control channel data encoding.

FIG. 9 depicts an example associated with consistency between model training and usage for uplink control channel data encoding.

FIG. 10 depicts a method for wireless communications.

FIG. 11 depicts aspects of an example communications device.

FIG. 12 depicts another method for wireless communications.

FIG. 13 depicts aspects of an example communications device.

FIG. 14 depicts another method for wireless communications.

FIG. 15 depicts aspects of an example communications device.

FIG. 16 depicts another method for wireless communications.

FIG. 17 depicts aspects of an example communications device.

### DETAILED DESCRIPTION

Aspects of the present disclosure provide apparatuses, methods, processing systems, and computer-readable mediums for consistency between model training and usage for uplink control channel data encoding.

In some wireless communications systems, a UE may transmit a type of uplink communication in which probabilities of certain types of information being included in a given uplink communication are non-uniform. For example, the type of uplink communication may include feedback information, such as hybrid automatic repeat request (HARQ) feedback or a feedback codebook. In the context of feedback information (e.g., HARQ feedback), a “codebook” refers to a set of one or more (e.g., a matrix of one or more) feedback indications (e.g., acknowledgement (ACK) or negative ACK (NACK) indications) that can be transmitted via a single transmission (e.g., a single uplink transmission). In some cases, the UE may support HARQ feedback codebook transmissions. A HARQ feedback codebook transmission may include a feedback message that allows the UE provide a network entity with feedback regarding one or more downlink communications (e.g., one or more physical downlink shared channel (PDSCH) communications). As used herein, a codebook may be a sequence of bits, which may be constructed using feedback indications (e.g., ACK/NACK feedback, also referred to as HARQ-ACK data) associated with multiple downlink communications that are transmitted by a network entity for reception by a UE (e.g., during a feedback window). A codebook may include one or more codewords, and a given codeword may include a message or communication. For example, a codeword may include one or more feedback indications (e.g., a sequence of values including one or more HARQ-ACK data bit values) associated with the one or more downlink communications.

Further, a UE may communicate using one or more communication parameters that are configured to achieve a target error rate (e.g., a target block error rate (BLER)) for a given channel (e.g., a PDSCH). The UE may transmit a codebook indicating feedback (e.g., HARQ feedback) for the given channel. Because the communication parameter(s) are configured to achieve the target error rate for the given channel, the feedback for the given channel is biased and/or non-uniform. For example, if the target BLER for the given channel is 10%, then a probability that the feedback for a given communication (e.g., a given transport block) transmitted via the given channel is an ACK is 90%. In some examples, codebooks may be designed for uniform probability of messages with equal likelihood of the bit 0 and bit 1. In such examples, power is applied uniformly to all codewords in the codebook. For example, each codeword may be transmitted using the same transmit power. This can result in inefficient power usage by the wireless node transmitting the codebook.

In some examples, a UE may utilize techniques for power shaping associated with non-uniform message transmissions to improve power savings. For example, more power may be proportionately assigned to less likely symbols (e.g., less likely codewords) and less power to more likely symbols (e.g., more likely codewords) to reduce the average transmit power and improve error performance (e.g., to reduce the average transmit power associated with meeting a given target error rate). For example, the UE may scale a power of a codeword based on a probability associated with the codeword.

However, probabilities of respective codewords included in a codebook (e.g., included in uplink control channel data, such as HARQ-ACK data) may vary over time. Therefore, using a given encoder (e.g., the same encoder) to encode uplink control channel data (e.g., using a given codebook) may result in degraded communication performance in some examples. As used herein, “encoder” may refer to a codebook and a power shaping scheme (e.g., a set of power shaping parameters associated with respective codewords in the codebook). For example, the encoder may be configured or designed to improve performance of uplink control channel transmissions for a given data distribution (e.g., a probability distribution for codewords) associated with the uplink control channel transmissions. As the data distribution associated with the uplink control channel may change over time, a performance of uplink control channel transmissions transmitted by the UE (e.g., that are encoded using the encoder) may therefore be degraded in some cases, such as when the data distribution differs from the data distribution that was used to configure or design the encoder. However, the UE and a network entity may not be synchronized with respect to a current data distribution (e.g., a current probability distribution for codewords) associated with the uplink control channel. Therefore, modifying the encoding (and decoding) scheme associated with the uplink control channel (e.g., as the data distribution changes) can result in errors (e.g., decoding errors) or failed uplink control channel communications.

To address this issue, in some wireless communications systems, a model associated with encoding (and decoding) of uplink control channel data can be used to tailor encoding (and decoding) operations to a data distribution associated with the uplink control channel (e.g., to a HARQ-ACK data distribution). The uplink control channel may be, for example, a physical uplink control channel (PUCCH). In some aspects, the model may be a data distribution model configured to output or generate one or more model parameters that are indicative of the data distribution of the uplink control channel. The model may be, for example, an autoregressive model, a transformer, or another model configured to output an inference or prediction of a probability of occurrence for one or more codewords. In a practical example, a UE may obtain, using the model, the one or more model parameters based on one or more historical (e.g., previously transmitted) uplink control channel transmissions. The UE can then encode uplink control channel data by using the one or more model parameters. For example, an encoder (e.g., a codebook and/or one or more power shaping parameters) may be based on the one or more model parameters. As a particular example, the encoder may include a codebook and/or one or more power shaping parameters that are determined (e.g., selected or calculated) using the one or more model parameters and/or the data distribution. That is, the UE may learn or otherwise determine a scenario-specific (e.g., data-distribution-specific) encoder for encoding the uplink control channel. The network entity may decode the uplink control channel data by using the one or more model parameters (e.g., using a decoder and/or a codebook and/or one or more power shaping parameters used for the encoding). For example, the network entity may use the one or more model parameters to determine a prior data distribution associated with the decoder, such as a maximum a posteriori (MAP)-based decoder. Additionally or alternatively, the network entity may decode the data using a codebook and/or one or more power shaping parameters that are determined using the one or more model parameters and/or the data distribution (e.g., using the encoder that is associated with the one or more model parameters). In general, encoding and decoding of the uplink control channel in a manner that is tailored based on a data distribution of the uplink control channel (e.g., a probability distribution associated with one or more codewords) can improve the performance of communications via the uplink control channel (e.g., improve encoding and/or decoding performance), meaning that reliability and power efficiency of the uplink control channel is increased.

Technical problems with respect to the use of models for encoding and decoding of uplink control channel data in the manner described above include ensuring consistency between model training and usage. For example, consistency between model training and usage may ensure that that a given model for encoding uplink control channel data is used in scenarios that are sufficiently similar to those in which the model is trained (e.g., so as to provide stable, reliable, and predictable outputs). To provide consistency, it may be desirable for a network to control scenarios in which a UE is permitted to train or use a model for encoding uplink control channel data. For example, it may be desirable for a network to permit a UE to use a model for encoding uplink control channel data for data distributions of the uplink control channel that are similar to those based on which the model is trained. Therefore, it is also desirable to control the scenarios in which the UE is permitted to train the model. Such control is desirable to, for example, limit (e.g., select or prioritize) the training and usage of such a model to scenarios in which model performance is known to achieve a desired outcome, such as increased reliability or improved power efficiency.

Further, to reduce complexity at a network entity, it may be desirable to allow a network entity to choose to use a model for decoding uplink control channel data that works across encoders of the different UEs connected to the network entity. This is desirable as the network entity does not need to manage its decoder per UE rather than it can be managed based on HARQ ACK distributions.

Aspects described herein may overcome the aforementioned technical problems, for example, by enabling consistency between model training and usage for uplink control channel data encoding. In some aspects, a UE may receive, from a network entity, information indicating a set of criteria for training or using a model associated with encoding uplink control channel data. In some example, the set of criteria includes a criterion associated with an uplink control channel data distribution (e.g., a HARQ-ACK distribution). In some aspects, the UE may determine that at least one of the criteria (e.g., the criterion associated with the uplink control channel data distribution) is satisfied, and may perform one or more operations associated with training or using the model based at least in part on the determination.

Additionally or alternatively, in some aspects, a network entity may obtain from one or more UEs and according to a reporting configuration, an uplink control channel data distribution dataset including a plurality of uplink control channel data distribution values associated with the one or more UEs, with each uplink control channel data distribution value being associated with one or more conditions. In some aspects, the network entity may determine an expected uplink control channel data distribution value for a given UE based at least in part on the uplink control channel data distribution dataset and a set of current conditions associated with the given UE. The network entity may then transmit the expected uplink control channel data distribution value to the UE. In some aspects, the UE may then perform one or more operations associated with using a model based at least in part on the expected uplink control channel data distribution value.

Certain techniques for promoting consistency between model training and usage for uplink control channel data encoding described herein may provide various beneficial technical effects and/or advantages. For example, the techniques for may enable improved wireless communications performance, such as improved reliability with respect to uplink control channel communications, reduced complexity at a network entity, and/or improved power efficiency with respect to transmission of uplink control channel data. The improved reliability, reduced complexity at the network entity, and the improved power efficiency may be attributable to the techniques and apparatuses described herein, for example, due to the network control of scenarios in which a UE is permitted to train or use a model for encoding uplink control channel data such that consistency between model training and usage is achieved.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

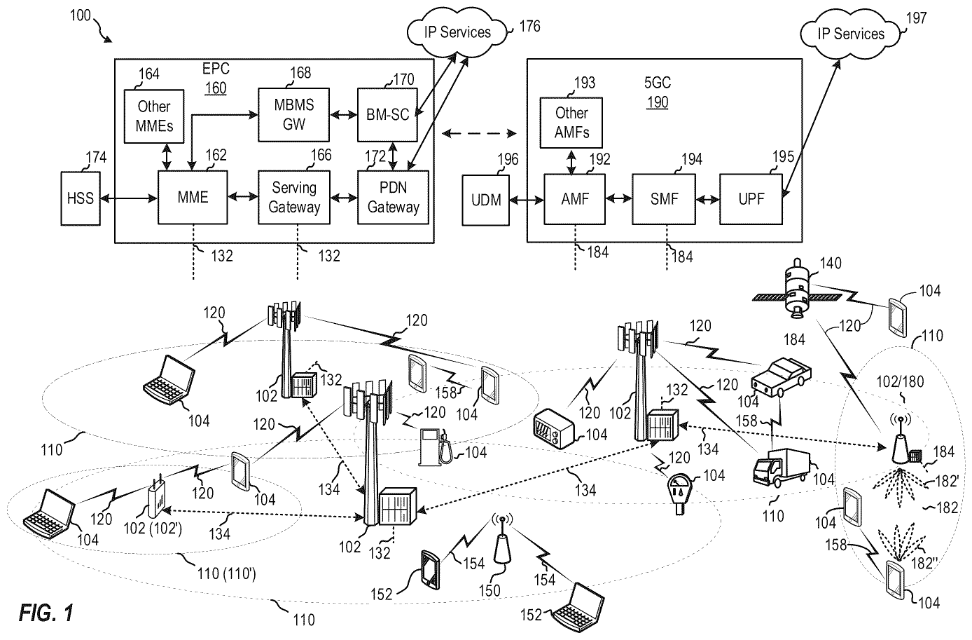

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

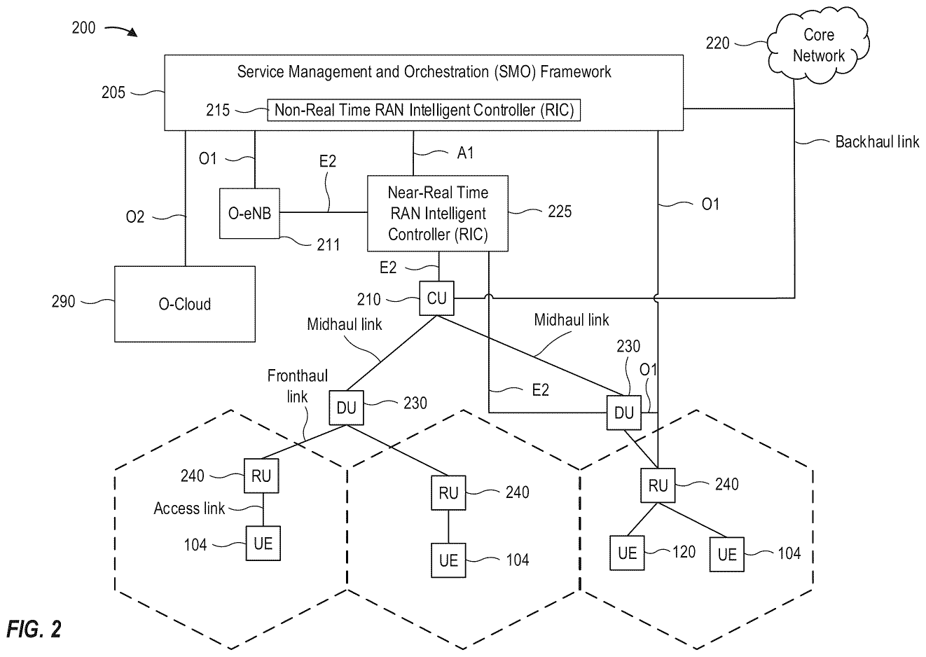

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR 1) as including 410 MHz-7125 MHz, which is often referred to (interchangeably) as “Sub-6 GHz”. Similarly, 3GPP currently defines Frequency Range 2 (FR 2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information. 5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

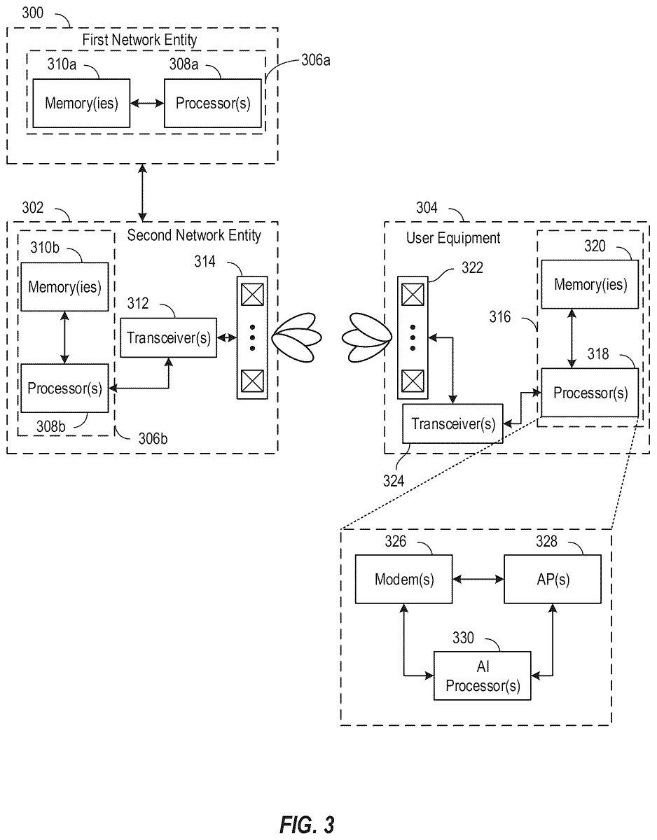

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

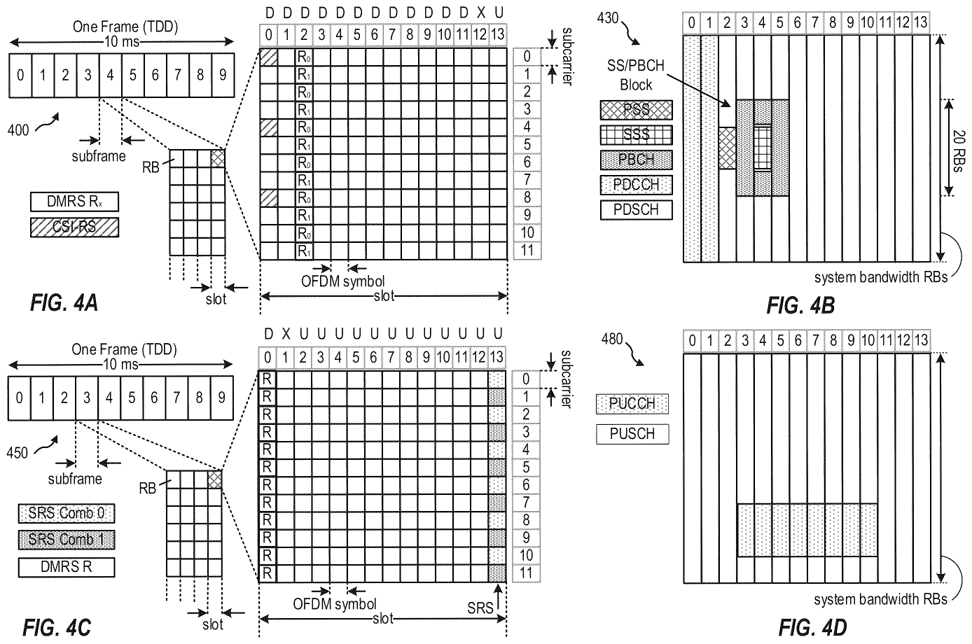

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2^{μ}slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Artificial Intelligence for Wireless Communications

Certain aspects described herein may be implemented, at least in part, using some form of artificial intelligence (AI), e.g., the process of using a machine learning (ML) model to infer or predict output data based on input data. An example ML model may include a mathematical representation of one or more relationships among various objects to provide an output representing one or more predictions or inferences. Once an ML model has been trained, the ML model may be deployed to process data that may be similar to, or associated with, all or part of the training data and provide an output representing one or more predictions or inferences based on the input data.

ML is often characterized in terms of types of learning that generate specific types of learned models that perform specific types of tasks. For example, different types of machine learning include supervised learning, unsupervised learning, semi-supervised learning, and reinforcement learning.

ML models may be deployed in one or more devices (e.g., network entities such as base station(s) and/or user equipment(s)) to support various wired and/or wireless communication aspects of a communication system. For example, an ML model may be trained to identify patterns and relationships in data corresponding to a network, a device, an air interface, or the like. An ML model may improve operations relating to one or more aspects, such as transceiver circuitry controls, frequency synchronization, timing synchronization, channel state estimation, channel equalization, channel state feedback, modulation, demodulation, device positioning, transceiver tuning, beamforming, signal coding/decoding, network routing, load balancing, and energy conservation (to name just a few) associated with communications devices, services, and/or networks. AI-enhanced transceiver circuitry controls may include, for example, filter tuning, transmit power controls, gain controls (including automatic gain controls), phase controls, power management, and the like.

Aspects described herein may describe the performance of certain tasks and the technical solution of various technical problems by application of a specific type of ML model, such as an ANN. It should be understood, however, that other type(s) of AI models may be used in addition to or instead of an ANN. An ML model may be an example of an AI model, and any suitable AI model may be used in addition to or instead of any of the ML models described herein. Hence, unless expressly recited, subject matter regarding an ML model is not necessarily intended to be limited to just an ANN solution or machine learning. Further, it should be understood that, unless otherwise specifically stated, terms such “AI model,” “ML model,” “AI/ML model,” “trained ML model,” and the like are intended to be interchangeable.

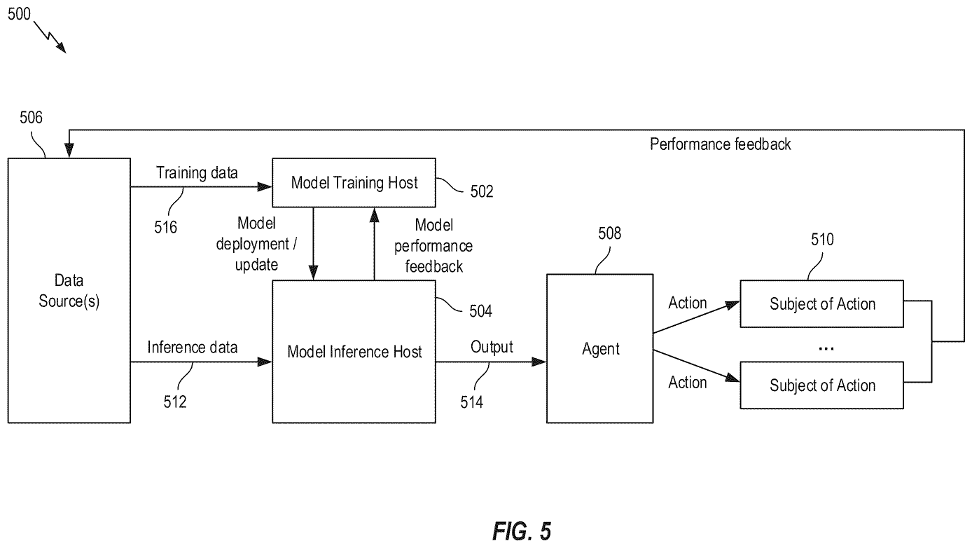

FIG. 5 is a diagram illustrating an example AI architecture 500 that may be used for AI-enhanced wireless communications. As illustrated, the AI architecture 500 includes multiple logical entities, such as a model training host 502, a model inference host 504, data source(s) 506, and an agent 508. The AI architecture may be used in any of various use cases for wireless communications, such as those listed above.

The model inference host 504, in the architecture 500, is configured to run an ML model based on inference data 512 provided by data source(s) 506. The model inference host 504 may produce an output 514 (e.g., a prediction or inference, such as a discrete or continuous value) based on the inference data 512, that is then provided as input to the agent 508. In certain aspects, the model inference host 504 may be an example of a model inference agent.

The agent 508 may be an element or an entity of a wireless communication system including, for example, a radio access network (RAN), a wireless local area network, a device-to-device (D2D) communications system, or the like (e.g., as depicted and described above with respect to FIGS. 1-4D. In certain examples, the agent 508 may be an example of a decision agent. In some examples, the agent 508 may be a UE, a base station, or any disaggregated network entity thereof including a CU, a DU, and/or an RU, an access point, a wireless station, a RIC in a cloud-based RAN, among some examples. Additionally, the type of agent 508 may also depend on the type of tasks performed by the model inference host 504, the type of inference data 512 provided to model inference host 504, and/or the type of output 514 produced by model inference host 504.

For example, if output 514 from the model inference host 504 is associated with beam management, the agent 508 may be or include a UE, a DU, or an RU. As another example, if output 514 from model inference host 504 is associated with transmission and/or reception scheduling, the agent 508 may be a CU or a DU.

After the agent 508 receives output 514 from the model inference host 504, agent 508 may determine whether to act based on the output. For example, if agent 508 is a DU or an RU and the output from model inference host 504 is associated with beam management, the agent 508 may determine whether to change or modify a transmit and/or receive beam based on the output 514. If the agent 508 determines to act based on the output 514, agent 508 may indicate the action to at least one subject of the action 510. For example, if the agent 508 determines to change or modify a transmit and/or receive beam for a communication between the agent 508 and the subject of action 510 (e.g., a UE), the agent 508 may send a beam switching indication to the subject of action 510 (e.g., a UE). As another example, the agent 508 may be a UE, the output 514 from model inference host 504 may be one or more predicted channel characteristics for one or more beams. For example, the model inference host 504 may predict channel characteristics for a set of beams based on the measurements of another set of beams. Based on the predicted channel characteristics, the agent 508, such as the UE, may send, to the subject of action 510, such as a BS, a request to switch to a different beam for communications. In some cases, the agent 508 and the subject of action 510 are the same entity.

The data sources 506 may be configured for collecting data that is used as training data 516 for training an ML model, or as inference data 512 for feeding an ML model inference operation. In particular, the data sources 506 may collect data from any of various entities (e.g., the UE and/or the BS), which may include the subject of action 510, and provide the collected data to a model training host 502 for ML model training. For example, after a subject of action 510 (e.g., a UE) receives a beam configuration from agent 508, the subject of action 510 may provide performance feedback associated with the beam configuration to the data sources 506, where the performance feedback may be used by the model training host 502 for monitoring and/or evaluating the ML model performance, such as whether the output 514, provided to agent 508, is accurate. In some examples, if the output 514 provided to agent 508 is inaccurate (or the accuracy is below an accuracy threshold), the model training host 502 may determine to modify or retrain the ML model used by model inference host 504, such as via an ML model deployment/update.

In certain aspects, the model training host 502 may be deployed at or with the same or a different entity than that in which the model inference host 504 is deployed. For example, in order to offload model training processing, which can impact the performance of the model inference host 504, the model training host 502 may be deployed at a model server as further described herein. Further, in some cases, training and/or inference may be distributed amongst devices in a decentralized or federated fashion.

In some aspects, an ML model is deployed at or on a network entity for decoding uplink control channel data (e.g., PUCCH data). More specifically, a model inference host, such as model inference host 504 in FIG. 5, may be deployed at or on the network entity for decoding PUCCH data.

In some other aspects, an ML model is deployed at or on a UE for encoding uplink control channel data. More specifically, a model inference host, such as model inference host 504 in FIG. 5, may be deployed at or on the UE for encoding PUCCH data.

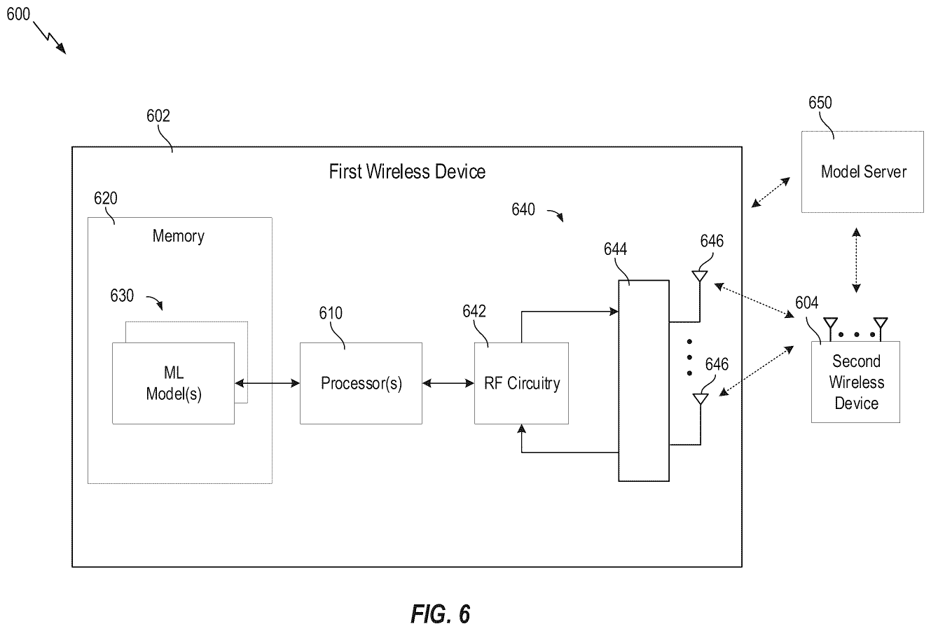

FIG. 6 illustrates an example AI architecture 600 of a first wireless device 602 that is in communication with a second wireless device 604. For example, the first wireless device 602 may be a UE as described herein with respect to FIGS. 1-3. Similarly, the second wireless device 604 may be a network entity or network node as described herein with respect to FIGS. 1-3. Note that the AI architecture of the first wireless device 602 may be applied to the second wireless device 604.

The first wireless device 602 may be, or may include, a chip, system on chip (SoC), a system in package (SiP), chipset, package or device that includes one or more processors, processing blocks or processing elements (collectively “the processor 610”) and one or more memory blocks or elements (collectively “the memory 620”).

As an example, in a transmit mode, the processor 610 may transform information (e.g., packets or data blocks) into modulated symbols. As digital baseband signals (e.g., digital in-phase (I) and/or quadrature (Q) baseband signals representative of the respective symbols), the processor 610 may output the modulated symbols to a transceiver 640. The processor 610 may be coupled to the transceiver 640 for transmitting and/or receiving signals via one or more antennas 646. In this example, the transceiver 640 includes radio frequency (RF) circuitry 642, which may be coupled to the antennas 646 via an interface 644. As an example, the interface 644 may include a switch, a duplexer, a diplexer, a multiplexer, and/or the like. The RF circuitry 642 may convert the digital signals to analog baseband signals, for example, using a digital-to-analog converter. The RF circuitry 642 may include any of various circuitry, including, for example, baseband filter(s), mixer(s), frequency synthesizer(s), power amplifier(s), and/or low noise amplifier(s). In some cases, the RF circuitry 642 may upconvert the baseband signals to one or more carrier frequencies for transmission. The antennas 646 may emit RF signals, which may be received at the second wireless device 604.

In receive mode, RF signals received via the antenna 646 (e.g., from the second wireless device 604) may be amplified and converted to a baseband frequency (e.g., downconverted). The received baseband signals may be filtered and converted to digital I or Q signals for digital signal processing. The processor 610 may receive the digital I or Q signals and further process the digital signals, for example, demodulating the digital signals.

One or more ML models 630 may be stored in the memory 620 and accessible to the processor(s) 610. In certain cases, different ML models 630 with different characteristics may be stored in the memory 620, and a particular ML model 630 may be selected based on its characteristics and/or application as well as characteristics and/or conditions of first wireless device 602 (e.g., a power state, a mobility state, a battery reserve, a temperature, etc.). For example, the ML models 630 may have different inference data and output pairings (e.g., different types of inference data produce different types of output), different levels of accuracies (e.g., 80%, 90%, or 95% accurate) associated with the predictions (e.g., the output 514 of FIG. 5), different latencies (e.g., processing times of less than 10 ms, 100 ms, or 1 second) associated with producing the predictions, different ML model sizes (e.g., file sizes), different coefficients or weights, etc.

The processor 610 may use the ML model 630 to produce output data (e.g., the output 514 of FIG. 5) based on input data (e.g., the inference data 512 of FIG. 5), for example, as described herein with respect to the inference host 504 of FIG. 5. The ML model 630 may be used to perform any of various AI-enhanced tasks, such as those listed above.

As an example, the ML model 630 may take measurements of a reference signal (e.g., corresponding to a wide beam) as input to predict a channel characteristic associated with a different reference signal (e.g., corresponding to a narrow beam within the wide beam, another wide beam, a narrow beam outside the wide beam, etc.). The input data may include, for example, measurements of one or more reference or pilot signals, such as a channel quality indicator (CQI), a signal-to-noise ratio (SNR), a signal-to-interference plus noise ratio (SINR), a signal-to-noise-plus-distortion ratio (SNDR), a received signal strength indicator (RSSI), a reference signal received power (RSRP), a reference signal received quality (RSRQ), and/or a block error rate (BLER). The output data may include, for example, one or more predicted measurements (or characteristics) of one or more reference or pilot signals, which may be different from the reference or pilot signals associated with the input data. In certain aspects, a model server 650 may perform any of various ML model lifecycle management (LCM) tasks for the first wireless device 602 and/or the second wireless device 604. The model server 650 may operate as the model training host 502 and update the ML model 630 using training data. In some cases, the model server 650 may operate as the data source 506 to collect and host training data, inference data, and/or performance feedback associated with an ML model 630. In certain aspects, the model server 650 may host various types and/or versions of the ML models 630 for the first wireless device 602 and/or the second wireless device 604 to download.

In some cases, the model server 650 may monitor and evaluate the performance of the ML model 630 to trigger one or more LCM tasks. For example, the model server 650 may determine whether to activate or deactivate the use of a particular ML model at the first wireless device 602 and/or the second wireless device 604, and the model server 650 may provide such an instruction to the respective first wireless device 602 and/or the second wireless device 604. In some cases, the model server 650 may determine whether to switch to a different ML model 630 being used at the first wireless device 602 and/or the second wireless device 604, and the model server 650 may provide such an instruction to the respective first wireless device 602 and/or the second wireless device 604. In yet further examples, the model server 650 may also act as a central server for decentralized machine learning tasks, such as federated learning.

### Example Artificial Intelligence Model

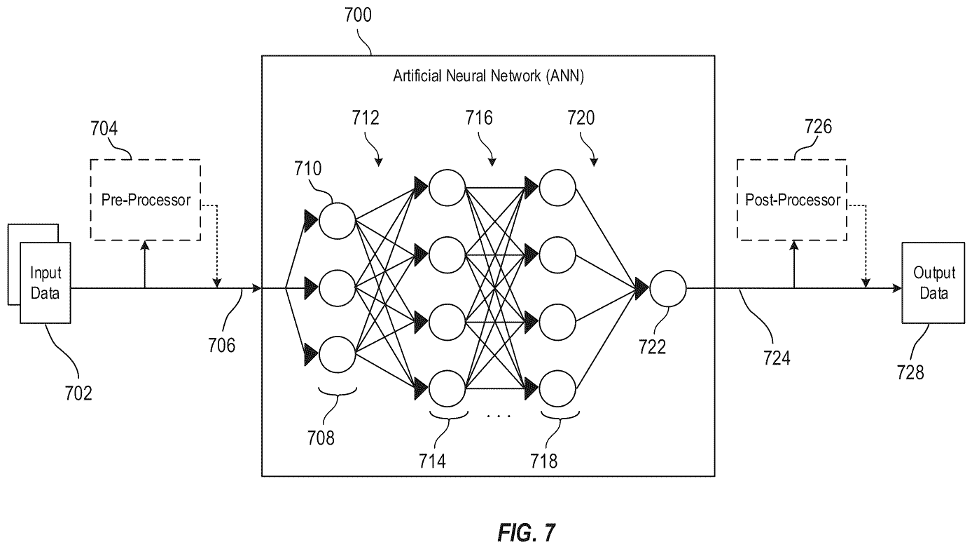

FIG. 7 is an illustrative block diagram of an example artificial neural network (ANN) 700.

ANN 700 may receive input data 706 which may include one or more bits of data 702, pre-processed data output from pre-processor 704 (optional), or some combination thereof. Here, data 702 may include training data, verification data, application-related data, or the like, e.g., depending on the stage of development and/or deployment of ANN 700. Pre-processor 704 may be included within ANN 700 in some other implementations. Pre-processor 704 may, for example, process all or a portion of data 702 which may result in some of data 702 being changed, replaced, deleted, etc. In some implementations, pre-processor 704 may add additional data to data 702.

ANN 700 includes at least one first layer 708 of artificial neurons 710 (e.g., perceptrons) to process input data 706 and provide resulting first layer output data via edges 712 to at least a portion of at least one second layer 714. Second layer 714 processes data received via edges 712 and provides second layer output data via edges 716 to at least a portion of at least one third layer 718. Third layer 718 processes data received via edges 716 and provides third layer output data via edges 720 to at least a portion of a final layer 722 including one or more neurons to provide output data 724. All or part of output data 724 may be further processed in some manner by (optional) post-processor 726. Thus, in certain examples, ANN 700 may provide output data 728 that is based on output data 724, post-processed data output from post-processor 726, or some combination thereof. Post-processor 726 may be included within ANN 700 in some other implementations. Post-processor 726 may, for example, process all or a portion of output data 724 which may result in output data 728 being different, at least in part, to output data 724, e.g., as result of data being changed, replaced, deleted, etc. In some implementations, post-processor 726 may be configured to add additional data to output data 724. In this example, second layer 714 and third layer 718 represent intermediate or hidden layers that may be arranged in a hierarchical or other like structure. Although not explicitly shown, there may be one or more further intermediate layers between the second layer 714 and the third layer 718.

The structure and training of artificial neurons 710 in the various layers may be tailored to specific requirements of an application. Within a given layer of an ANN, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to weights and biases that may be adjusted during a training process. Weights of the various artificial neurons may act as parameters to control a strength of connections between layers or artificial neurons, while biases may act as parameters to control a direction of connections between the layers or artificial neurons. An activation function may select or determine whether an artificial neuron transmits its output to the next layer or not in response to its received data. Different activation functions may be used to model different types of non-linear relationships. By introducing non-linearity into an ML model, an activation function allows the ML model to “learn” complex patterns and relationships in the input data (e.g., 506 in FIG. 5). Some non-exhaustive example activation functions include a linear function, binary step function, sigmoid, hyperbolic tangent (tanh), a rectified linear unit (ReLU) and variants, exponential linear unit (ELU), Swish, Softmax, and others.

Design tools (such as computer applications, programs, etc.) may be used to select appropriate structures for ANN 700 and a number of layers and a number of artificial neurons in each layer, as well as selecting activation functions, a loss function, training processes, etc. Once an initial model has been designed, training of the model may be conducted using training data. Training data may include one or more datasets within which ANN 700 may detect, determine, identify or ascertain patterns. Training data may represent various types of information, including written, visual, audio, environmental context, operational properties, etc. During training, parameters of artificial neurons 710 may be changed, such as to minimize or otherwise reduce a loss function or a cost function. A training process may be repeated multiple times to fine-tune ANN 700 with each iteration.

Various ANN model structures are available for consideration. For example, in a feedforward ANN structure each artificial neuron 710 in a layer receives information from the previous layer and likewise produces information for the next layer. In a convolutional ANN structure, some layers may be organized into filters that extract features from data (e.g., training data and/or input data). In a recurrent ANN structure, some layers may have connections that allow for processing of data across time, such as for processing information having a temporal structure, such as time series data forecasting.

In an autoencoder ANN structure, compact representations of data may be processed and the model trained to predict or potentially reconstruct original data from a reduced set of features. An autoencoder ANN structure may be useful for tasks related to dimensionality reduction and data compression.

A generative adversarial ANN structure may include a generator ANN and a discriminator ANN that are trained to compete with each other. Generative-adversarial networks (GANs) are ANN structures that may be useful for tasks relating to generating synthetic data or improving the performance of other models.

A transformer ANN structure makes use of attention mechanisms that may enable the model to process input sequences in a parallel and efficient manner. An attention mechanism allows the model to focus on different parts of the input sequence at different times. Attention mechanisms may be implemented using a series of layers known as attention layers to compute, calculate, determine or select weighted sums of input features based on a similarity between different elements of the input sequence. A transformer ANN structure may include a series of feedforward ANN layers that may learn non-linear relationships between the input and output sequences. The output of a transformer ANN structure may be obtained by applying a linear transformation to the output of a final attention layer. A transformer ANN structure may be of particular use for tasks that involve sequence modeling, or other like processing.

Another example type of ANN structure, is a model with one or more invertible layers. Models of this type may be inverted or “unwrapped” to reveal the input data that was used to generate the output of a layer.

Other example types of ANN model structures include fully connected neural networks (FCNNs) and long short-term memory (LSTM) networks.

ANN 700 or other ML models may be implemented in various types of processing circuits along with memory and applicable instructions therein, for example, as described herein with respect to FIGS. 5 and 6. For example, general-purpose hardware circuits, such as, such as one or more central processing units (CPUs) and one or more graphics processing units (GPUs) may be employed to implement a model. One or more ML accelerators, such as tensor processing units (TPUs), embedded neural processing units (eNPUs), or other special-purpose processors, and/or field-programmable gate arrays (FPGAs), application-specific integrated circuits (ASICs), or the like also may be employed. Various programming tools are available for developing ANN models.

### Aspects of Artificial Intelligence Model Training

There are a variety of model training techniques and processes that may be used prior to, or at some point following, deployment of an ML model, such as ANN 700 of FIG. 7.

As part of a model development process, information in the form of applicable training data may be gathered or otherwise created for use in training an ML model accordingly. For example, training data may be gathered or otherwise created regarding information associated with received/transmitted signal strengths, interference, and resource usage data, as well as any other relevant data that might be useful for training a model to address one or more problems or issues in a communication system. In certain instances, all or part of the training data may originate in one or more user equipments (UEs), one or more network entities, or one or more other devices in a wireless communication system. In some cases, all or part of the training data may be aggregated from multiple sources (e.g., one or more UEs, one or more network entities, the Internet, etc.). For example, wireless network architectures, such as self-organizing networks (SONs) or mobile drive test (MDT) networks, may be adapted to support collection of data for ML model applications. In another example, training data may be generated or collected online, offline, or both online and offline by a UE, network entity, or other device(s), and all or part of such training data may be transferred or shared (in real or near-real time), such as through store and forward functions or the like. Offline training may refer to creating and using a static training dataset, e.g., in a batched manner, whereas online training may refer to a real-time or near-real-time collection and use of training data. For example, an ML model at a network device (e.g., a UE) may be trained and/or fine-tuned using online or offline training. For offline training, data collection and training can occur in an offline manner at the network side (e.g., at a base station or other network entity) or at the UE side. For online training, the training of a UE-side ML model may be performed locally at the UE or by a server device (e.g., a server hosted by a UE vendor) in a real-time or near-real-time manner based on data provided to the server device from the UE.

In certain instances, all or part of the training data may be shared within a wireless communication system, or even shared (or obtained from) outside of the wireless communication system.

Once an ML model has been trained with training data, its performance may be evaluated. In some scenarios, evaluation/verification tests may use a validation dataset, which may include data not in the training data, to compare the model's performance to baseline or other benchmark information. If model performance is deemed unsatisfactory, it may be beneficial to fine-tune the model, e.g., by changing its architecture, re-training it on the data, or using different optimization techniques, etc. Once a model's performance is deemed satisfactory, the model may be deployed accordingly. In certain instances, a model may be updated in some manner, e.g., all or part of the model may be changed or replaced, or undergo further training, just to name a few examples.

As part of a training process for an ANN, such as ANN 700 of FIG. 7, parameters affecting the functioning of the artificial neurons and layers may be adjusted. For example, backpropagation techniques may be used to train the ANN by iteratively adjusting weights and/or biases of certain artificial neurons associated with errors between a predicted output of the model and a desired output that may be known or otherwise deemed acceptable. Backpropagation may include a forward pass, a loss function, a backward pass, and a parameter update that may be performed in training iteration. The process may be repeated for a certain number of iterations for each set of training data until the weights of the artificial neurons/layers are adequately tuned.

Backpropagation techniques associated with a loss function may measure how well a model is able to predict a desired output for a given input. An optimization algorithm may be used during a training process to adjust weights and/or biases to reduce or minimize the loss function which should improve the performance of the model. There are a variety of optimization algorithms that may be used along with backpropagation techniques or other training techniques. Some initial examples include a gradient descent based optimization algorithm and a stochastic gradient descent based optimization algorithm. A stochastic gradient descent (or ascent) technique may be used to adjust weights/biases in order to minimize or otherwise reduce a loss function. A mini-batch gradient descent technique, which is a variant of gradient descent, may involve updating weights/biases using a small batch of training data rather than the entire dataset. A momentum technique may accelerate an optimization process by adding a momentum term to update or otherwise affect certain weights/biases.

An adaptive learning rate technique may adjust a learning rate of an optimization algorithm associated with one or more characteristics of the training data. A batch normalization technique may be used to normalize inputs to a model in order to stabilize a training process and potentially improve the performance of the model.

A “dropout” technique may be used to randomly drop out some of the artificial neurons from a model during a training process, e.g., in order to reduce overfitting and potentially improve the generalization of the model.

An “early stopping” technique may be used to stop an on-going training process early, such as when a performance of the model using a validation dataset starts to degrade.

Another example technique includes data augmentation to generate additional training data by applying transformations to all or part of the training information.

A transfer learning technique may be used which involves using a pre-trained model as a starting point for training a new model, which may be useful when training data is limited or when there are multiple tasks that are related to each other.

A multi-task learning technique may be used which involves training a model to perform multiple tasks simultaneously to potentially improve the performance of the model on one or more of the tasks. Hyperparameters or the like may be input and applied during a training process in certain instances.

Another example technique that may be useful with regard to an ML model is some form of a “pruning” technique. A pruning technique, which may be performed during a training process or after a model has been trained, involves the removal of unnecessary (e.g., because they have no impact on the output) or less necessary (e.g., because they have negligible impact on the output), or possibly redundant features from a model. In certain instances, a pruning technique may reduce the complexity of a model or improve efficiency of a model without undermining the intended performance of the model.

Pruning techniques may be particularly useful in the context of wireless communication, where the available resources (such as power and bandwidth) may be limited. Some example pruning techniques include a weight pruning technique, a neuron pruning technique, a layer pruning technique, a structural pruning technique, and a dynamic pruning technique. Pruning techniques may, for example, reduce the amount of data corresponding to a model that may need to be transmitted or stored.

Weight pruning techniques may involve removing some of the weights from a model. Neuron pruning techniques may involve removing some neurons from a model. Layer pruning techniques may involve removing some layers from a model. Structural pruning techniques may involve removing some connections between neurons in a model. Dynamic pruning techniques may involve adapting a pruning strategy of a model associated with one or more characteristics of the data or the environment. For example, in certain wireless communication devices, a dynamic pruning technique may more aggressively prune a model for use in a low-power or low-bandwidth environment, and less aggressively prune the model for use in a high-power or high-bandwidth environment. In certain aspects, pruning techniques also may be applied to training data, e.g., to remove outliers, etc. In some implementations, pre-processing techniques directed to all or part of a training dataset may improve model performance or promote faster convergence of a model. For example, training data may be pre-processed to change or remove unnecessary data, extraneous data, incorrect data, or otherwise identifiable data. Such pre-processed training data may, for example, lead to a reduction in potential overfitting, or otherwise improve the performance of the trained model.

One or more of the example training techniques presented above may be employed as part of a training process. As above, some example training processes that may be used to train an ML model include supervised learning, unsupervised learning, semi-supervised learning, and reinforcement learning technique.

Decentralized, distributed, or shared learning, such as federated learning, may enable training on data distributed across multiple devices or organizations, without the need to centralize data or the training. Federated learning may be particularly useful in scenarios where data is sensitive or subject to privacy constraints, or where it is impractical, inefficient, or expensive to centralize data. In the context of wireless communication, for example, federated learning may be used to improve performance by allowing an ML model to be trained on data collected from a wide range of devices and environments. For example, an ML model may be trained on data collected from a large number of wireless devices in a network, such as distributed wireless communication nodes, smartphones, or internet-of-things (IoT) devices, to improve the network's performance and efficiency. With federated learning, a user equipment (UE) or other device may receive a copy of all or part of a model and perform local training on such copy of all or part of the model using locally available training data. Such a device may provide update information (e.g., trainable parameter gradients) regarding the locally trained model to one or more other devices (such as a network entity or a server) where the updates from other-like devices (such as other UEs) may be aggregated and used to provide an update to a shared model or the like. A federated learning process may be repeated iteratively until all or part of a model obtains a satisfactory level of performance. Federated learning may enable devices to protect the privacy and security of local data, while supporting collaboration regarding training and updating of all or part of a shared model.

In some implementations, one or more devices or services may support processes relating to a ML model's usage, maintenance, activation, reporting, or the like. In certain instances, all or part of a dataset or model may be shared across multiple devices, e.g., to provide or otherwise augment or improve processing. In some examples, signaling mechanisms may be utilized at various nodes of wireless network to signal the capabilities for performing specific functions related to ML model, support for specific ML models, capabilities for gathering, creating, transmitting training data, or other ML related capabilities. ML models in wireless communication systems may, for example, be employed to support decisions relating to wireless resource allocation or selection, wireless channel condition estimation, interference mitigation, beam management, positioning accuracy, energy savings, or modulation or coding schemes, etc. In some implementations, model deployment may occur jointly or separately at various network levels, such as, a central unit (CU), a distributed unit (DU), a radio unit (RU), or the like.

### Example Signaling for Consistency Between Model Training and Usage for Uplink Control Channel Data Encoding

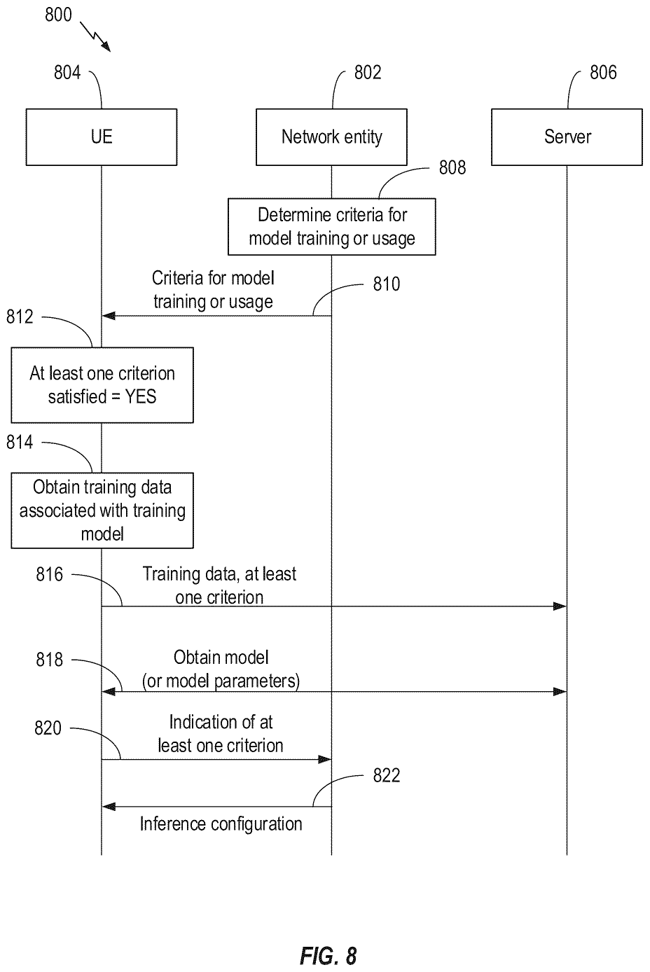

FIG. 8 depicts a process flow 800 for communications in a network between a network entity 802, a user equipment (UE) 804, and a server 806. In some aspects, the network entity 802 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 804 may be an example of UE 104 depicted and described with respect to FIG. 1 or the UE 304 depicted and described with respect to FIG. 3. However, in other aspects, UE 804 may be another type of wireless communications device and network entity 802 may be another type of network entity or network node, such as those described herein. The server 806 may be a device configured to store, maintain, train, or otherwise manage one or more models (or sets of parameters for one or more models) associated with encoding or decoding uplink control channel data. In some aspects, the server 806 may be an example of a BS 102 depicted and described with respect to FIG. 1, the first network entity 300 or the second network entity 302 depicted and described with respect to FIG. 3, or a disaggregated base station depicted and described with respect to FIG. 2. In some aspects, the server 806 may be included in (e.g., co-located with) the network entity 802. Additionally or alternatively, the server 806 may comprise a separate device that is included in the network 100.

At 808, the network entity 802 may determine a set of criteria for training or using a model associated with encoding uplink control channel data. In some aspects, the set of criteria includes one or more criteria based on which the UE 804 is permitted to train or use a model associated with encoding uplink control channel data. In general, the set of criteria may indicate or otherwise define a set of scenarios in which the UE 804 is permitted to train or use the model associated with encoding uplink control channel data. In some aspects, a given scenario may be defined by a single criterion (e.g., such that the UE 804 is to detect the given scenario at the UE 804 based on a determination that the single criterion is satisfied). Additionally or alternatively, a given scenario may be defined by multiple criteria in the set of criteria (e.g., such that the UE 804 is to detect the given scenario at the UE 804 based on a determination that each of the multiple criteria are satisfied). In some aspects, the set of criteria may define multiple scenarios (e.g., using different combinations of one or more criteria).

In some aspects, the set of criteria includes a criterion associated with an uplink control channel data distribution. For example, the uplink control channel data distribution may be a HARQ-ACK data distribution (e.g., a probability distribution of HARQ codewords). Thus, in some aspects, the set of criteria may include a criterion associated with a HARQ-ACK data distribution. The criterion associated with the HARQ-ACK data distribution may be, for example, a HARQ-ACK data distribution threshold. In some examples, the HARQ-ACK data distribution threshold may be used to control whether the UE 804 is permitted to train or use the model associated with encoding the uplink control channel data. For example, if a HARQ-ACK data distribution value associated with uplink control channel data of the UE 804 satisfies (e.g., is greater than, is less than, is within a configured range, or the like) the HARQ-ACK data distribution threshold, then the UE 804 may be permitted to train or use the model. Alternatively, if the HARQ-ACK data distribution value associated with uplink control channel data of the UE 804 fails to satisfy the HARQ-ACK data distribution threshold, then the UE 804 may not be permitted to train or use the model.

Additionally or alternatively, the set of criteria may include a criterion associated with a physical position of the UE 804 in a cell. The physical position of the UE 804 in the cell indicated by the criterion may be, for example, a center region of the cell (e.g., a region at or near the center of the cell), an edge region of the cell (e.g., a region at or near the edge of the cell), or a middle region of the cell (e.g., a region between center region and the edge region). Here, if the UE 804 is in a region of the cell indicated by the physical position criterion, then the UE 804 may be permitted to (or excluded from) training or using the model associated with encoding uplink control channel data. Otherwise, if the UE 804 is not in the region of the cell indicated by the physical position criterion, then the UE 804 may not be permitted to (or may not be excluded from) training or using the model associated with encoding uplink control channel data. Thus, in some aspects, the physical position of the UE 804 in the cell may be used to control whether the UE 804 is permitted to train or use the model associated with encoding the uplink control channel data.

Additionally or alternatively, the set of criteria may include a criterion associated with a connection of the UE 804 to one or more particular cells. For example, the criterion may indicate a list of particular cells. Here, if the UE 804 is connected to a cell indicated in the list of particular cells, then the UE 804 may be permitted to (or excluded from) training or using the model associated with encoding uplink control channel data. Otherwise, if the UE 804 is connected to a cell that is not indicated in the list of particular cells, then the UE 804 may not be permitted to (or, in an alternative configuration, may not be excluded from) training or using the model associated with encoding uplink control channel data. Thus, in some aspects, the cell to which the UE 804 is connected may be used to control whether the UE 804 is permitted to train or use the model associated with encoding the uplink control channel data.

Additionally or alternatively, the set of criteria may include a criterion associated with a connection of the UE to one or more particular beams on a set of cells. For example, the criterion may indicate a list of particular beams on one or more cells. Here, if the UE 804 is connected to a beam on a cell indicated in the list, then the UE 804 may be permitted to (or, in an alternative configuration, excluded from) training or using the model associated with encoding uplink control channel data. Otherwise, if the UE 804 is connected to a beam on a cell that is not indicated in the list, then the UE 804 may not be permitted to (or may not be excluded from) training or using the model associated with encoding uplink control channel data. Thus, in some aspects, the beam used by the UE 804 to connect to a given cell may be used to control whether the UE 804 is permitted to train or use the model associated with encoding the uplink control channel data.

Additionally or alternatively, the set of criteria may include a criterion associated with a configuration of the network entity 802. That is, the set of criteria may include a criterion associated with a network-side condition. One example of a configuration of the network entity 802 is a beam configuration of the network entity 802. In some aspects, the network entity 802 may implicitly signal the configuration of the network entity 802 to the UE 804 (e.g., using an identifier, an index, or the like). Additionally or alternatively, the network entity 802 may explicitly signal the configuration of the network entity 802 to the UE 804. Thus, in some aspects, one or more configurations of the network entity 802 may be used to control whether the UE 804 is permitted to train or use the model associated with encoding the uplink control channel data.

At reference 810, the network entity 802 may transmit, to the UE 804, information indicating the set of criteria for training or using the model associated with encoding uplink control channel data. In some aspects, the information indicating the set of criteria may be communicated in system information. Additionally or alternatively, the information indicating the set of criteria may be communicated in a radio resource control (RRC) message. Additionally or alternatively, the information indicating the set of criteria may be communicated in a medium access control (MAC) control element (CE). Additionally or alternatively, the information indicating the set of criteria may be communicated in downlink control information (DCI).

At reference 812, the UE 804 may determine that at least one criterion of the set of criteria is satisfied. That is, the UE 804 may determine that one or more criteria are satisfied, which indicates that one or more scenarios in which the UE 804 is permitted to train or use the model, as defined by the set of criteria, has been detected at the UE 804.

In some aspects, the at least one criterion may include the criterion associated with the uplink control channel data distribution (e.g., the HARQ-ACK data distribution). For example, the UE 804 may determine that a HARQ-ACK data distribution value of the UE 804 (e.g., a value indicative of a HARQ-ACK data distribution for a particular period of time) is greater than a HARQ-ACK data distribution threshold indicated in the set of criteria, meaning that the HARQ-ACK data distribution value of the UE 804 is sufficient so as to permit the UE 804 to train or use the model associated with encoding uplink control channel data.

In some aspects, the UE 804 may determine that multiple criteria from the set of criteria are satisfied. For example, the set of criteria may include a HARQ-ACK data distribution threshold range and a physical position criterion associated with a cell edge region. Here, the UE 804 may determine that a HARQ-ACK data distribution value of the UE 804 is within the HARQ-ACK data distribution threshold range and that the UE 804 is in an edge region of a cell to which the UE 804 is connected. In this example, the HARQ-ACK data distribution value of the UE 804 and the physical position of the UE 804 are sufficient so as to permit the UE 804 to train or use the model associated with encoding uplink control channel data.

In some aspects, the UE 804 may perform one or more operations associated with training the model based at least in part on determining that the at least one criterion is satisfied. For example, the one or more operations may include one or more operations associated with training the model. In some aspects, as shown at reference 814, the UE 804 may obtain training data associated with training the model. That is, upon detecting that the at least one criterion is satisfied (e.g., that a value of the HARQ-ACK data distribution satisfies a HARQ-ACK data distribution threshold), the UE 804 may collect (e.g., measure, calculate, or otherwise obtain) training data associated with training the model associated with encoding uplink control channel data. The training data may include, for example, a HARQ ACK and NACK sequence, channel information (e.g., a rank, a Precoding Matrix Indicator (PMI), or the like)

As shown at reference 816, in a further operation associated with training the model, the UE 804 may transmit the training data to the server 806 (or the network entity 802, when the server 806 is co-located with the network entity 802). As shown, in some aspects, the UE 804 may also transmit an indication of the at least one criterion that was determined to be satisfied (e.g., the satisfied criteria that triggered the UE 804 to obtain the training data). In this way, the UE 804 may provide the server 806 with data that can be used to train the model associated with encoding uplink control channel data, as well as information indicating one or more criteria associated with the training data (e.g., such that a scenario in which the training data was obtained is known to the server 806). In some aspects, the server 806 (or the network entity 802, when the server 806 is co-located with the network entity 802) may train one or more models based on the training data. In this way, the server 806 can obtain training data for a given scenario from one or more UEs 804, so as to enable the model to be trained for one or more scenarios defined by the set of criteria.

In some aspects, the UE 804 may perform one or more operations associated with using the model based at least in part on determining that the at least one criterion is satisfied. For example, as shown at reference 818, the UE 804 may obtain the model or a set of parameter values associated with the model in association with using the model. For example, the UE 804 may transmit, to the server 806, information indicating the at least on criterion that was determined to be satisfied by the UE 804. In some examples, the UE 804 may not store or have access to the model. In such examples, the server 806 (or the network entity 802) may transmit, to the UE 804, the model associated with encoding uplink control channel data. In some aspects, the server 806 (or the network entity 802) may identify the model based on the at least one criterion (e.g., based on the scenario indicated by the at least one criterion). That is, to be used by the UE 804 for the given scenario (e.g., a model trained for the given scenario or for a scenario that is sufficiently similar to the given scenario) may be identified and provided to the UE 804 for use for encoding uplink control channel data. Alternatively, in some examples, the UE 804 may store or have access to the model. In such examples, the server 806 (or the network entity 802) may transmit, to the UE 804, a set of parameters of the model associated with encoding uplink control channel data. In some aspects, the set of parameters may be identified based on the at least one criterion (e.g., based on the scenario indicated by the at least one criterion). That is, the set of parameters for the model to be used by the UE 804 may be identified for the given scenario (e.g., a set of model parameters for the given scenario or for a scenario that is sufficiently similar to the given scenario) and transmitted to the UE 804 accordingly.

At reference 820, the UE 804 may transmit, to the network entity 802, an indication that at least one criterion of the set of criteria is satisfied. For example, the UE 804 may transmit, the network entity 802, and indication of the at least one criterion that was determined to be satisfied (e.g., the satisfied criteria that triggered the UE 804 to use the model). In this way, the UE 804 may provide the network entity 802 with an indication that the UE 804 is to use the model in association with encoding uplink control channel data (e.g., such that a scenario in which the UE 804 is using the model is known to the network entity 802).

At reference 822, the network entity 802 may transmit, to the UE 804, an inference configuration that includes a set of parameter values associated with the model. That is, the network entity 802 may transmit, to the UE 804, a configuration including parameters associated with using the model for encoding the uplink control channel data (e.g., such that an inference can be made using the model). The inference configuration may include, for example, a HARQ ACK distribution for which AI/ML-based encoder to be used at the UE, a codebook to be used at the UE, a power shaping scheme to be used at the UE, or the like.

In some aspects, selection of the model used for with encoding uplink control channel data and/or activation/deactivation of operations as described with respect to the example process flow 800 may be performed by the UE 804 or the network entity 802. For example, selection of the model used for with encoding uplink control channel data and/or activation/deactivation of operations as described with respect to the example process flow 800 may be based on performance monitoring at the UE 804 or the network entity 802 or based on performance as reported from the UE 804 to the network entity 802.

In some aspects, the techniques for consistency between model training and usage for uplink control channel data encoding described with respect to the example 800 may enable improved wireless communications performance, such as improved reliability with respect to uplink control channel communications, reduced complexity at a network entity, or improved power efficiency with respect to transmission of uplink control channel data. The improved reliability, reduced complexity at the network entity, and the improved power efficiency may be attributable to the techniques and apparatuses described with respect to the techniques and apparatuses depicted and described with respect to the example 800, for example, due to the network control of scenarios in which a UE 804 is permitted to train or use a model for encoding uplink control channel data.

Note that the process flow illustrated in FIG. 8 is an example of consistency between model training and usage for uplink control channel data encoding, and aspects of the present disclosure may be applied to consistency between model training and usage for uplink control channel data encoding. Note that the process flow illustrated in FIG. 8 is described herein to facilitate an understanding of consistency between model training and usage for uplink control channel data encoding, and aspects of the present disclosure may be performed in various manners via alternative or additional signaling and/or operations. In certain aspects, the operations and/or signaling of FIG. 8 may occur in an order different from that described or depicted, and various actions, operations, and/or signaling may be added, omitted, or combined.

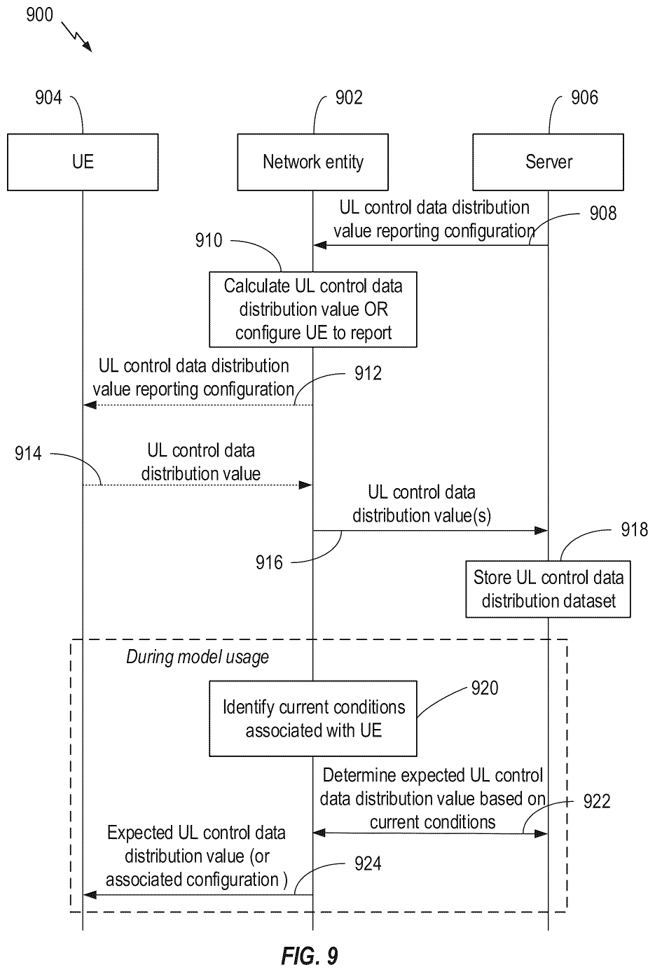

FIG. 9 depicts a process flow 900 for communications in a network between a network entity 902, a UE 904, and a server 906. In some aspects, the network entity 902 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 904 may be an example of UE 104 depicted and described with respect to FIG. 1 or the UE 304 depicted and described with respect to FIG. 3. However, in other aspects, UE 904 may be another type of wireless communications device and network entity 902 may be another type of network entity or network node, such as those described herein. The server 906 may be a device configured to store, maintain, train, or otherwise manage one or more models (or sets of parameters for one or more models) associated with encoding or decoding uplink control channel data and/or to obtain, store, maintain, or otherwise manage data associated with training the one or more models (e.g., HARQ-ACK distribution data, sets of criteria, or the like). In some aspects, the server 906 may be an example of an BS 102 depicted and described with respect to FIG. 1, the first network entity 300 or the second network entity 302 depicted and described with respect to FIG. 3, or a disaggregated base station depicted and described with respect to FIG. 2. In some aspects, the server 906 may be included in (e.g., co-located with) the network entity 902. Additionally or alternatively, the server 906 may be a separate device included in the network 100.

In some aspects, the server 906 (or the network entity 902, when the server 906 is co-located with the network entity 902) may obtain an uplink control channel data distribution dataset associated with one or more UEs 904. The uplink control channel data distribution dataset includes a plurality of uplink control channel data distribution values (e.g., one or more estimated uplink control channel data distribution values or one or more actual uplink control channel data distribution values, as described below). In some examples the uplink control channel data distribution dataset may include a plurality of HARQ-ACK data distribution values (e.g., probability distributions of HARQ codewords of HARQ feedback).

In some aspects, a given uplink control channel data distribution value (e.g., a given HARQ-ACK data distribution value) in the uplink control channel data distribution dataset is associated with one or more conditions. A condition may include, for example, a beam associated with communication of uplink control channel data (e.g., a beam via which a given UE 904 communicated uplink control channel data based on which the uplink control channel data distribution value was calculated). As another example, a condition may include a cell associated with the communication of the uplink control channel data (e.g., a cell to which the given UE 904 is connected for communication of uplink control channel data based on which the uplink control channel data distribution value was calculated). As another example, a condition may include a channel characteristic associated with the communication of the uplink control channel data (e.g., a characteristic of a wireless communication channel used to communicate the uplink control channel data based on which the uplink control channel data distribution value was calculated, such as an SNR). As another example, a condition may include a network-side condition associated with the communication of the uplink control channel data (e.g., a configuration of the network entity 802 to which the uplink control channel data is transmitted, such as a beam configuration of the network entity 902). As another example, a condition may include a UE type (e.g., an enhanced mobile broadband (eMBB) UE, a machine type communication (MTC) UE, a reduced capability (RedCap) UE, or the like). As another example, a condition may include a UE category (e.g., a value indicating a category that maps to an uplink or downlink performance capability of the UE 904). In general, the one or more conditions associated with a given uplink control channel data distribution value include one or more conditions associated with a UE 904 at a time at which the given uplink control channel data distribution value is calculated, measured, or otherwise determined (e.g., a scenario in which the given uplink control channel data distribution value is measured, calculated, or otherwise determined).

In some aspects, the uplink control channel data distribution dataset may be obtained based at least in part on an uplink control channel data distribution value reporting configuration. The uplink control channel data distribution value reporting configuration includes a configuration associated with calculation or reporting of uplink control channel data distribution values. The uplink control channel data distribution value reporting configuration may indicate, for example, a manner in which an uplink control channel data distribution value is to be calculated (e.g., a length of a time window associated with calculation of uplink control channel data distribution values), a manner in which the uplink control channel data distribution value is to be reported (e.g., a reporting periodicity), or another characteristic according to which an uplink control channel data distribution value is to be calculated or reported. In some aspects, as shown at reference 908, the network entity 902 may receive the uplink control channel data distribution value reporting configuration from the server 906.

In some aspects, as shown at reference 910, the network entity 902 may calculate one or more estimated uplink control channel data distribution values (e.g., one or more estimated HARQ-ACK data distribution values). For example, the network entity 902 may receive uplink control channel data (e.g., HARQ feedback) from a UE 904 over a period of time. In some such aspects, the network entity 902 may calculate one or more estimated uplink control channel data distribution values (e.g., each associated with a respective time window of a particular length) based at least in part on decoding the uplink control channel data received from the UE 904. In some aspects, the network entity 902 may calculate the one or more estimated uplink control channel data distribution values according to the uplink control channel data distribution value reporting configuration.

Additionally or alternatively, a UE 904 may calculate one or more actual uplink control channel data distribution values (e.g., one or more actual HARQ-ACK data distribution values). For example, as shown at reference 912, the network entity 902 may in some aspects transmit the uplink control channel data distribution value reporting configuration to the UE 904. The UE 904 may then calculate one or more actual uplink control channel data distribution values (e.g., each associated with a respective time window of a particular length) according to the uplink control channel data distribution value reporting configuration. As shown at reference 914, the UE 904 may transmit the one or more actual uplink control channel data distribution values to the network entity 902 (e.g., according to the uplink control channel data distribution value reporting configuration).

As shown at reference 916, the server 906 may obtain the uplink control channel data distribution dataset. That is, the server 906 may obtain a plurality of uplink control channel data distribution values (e.g., one or more estimated uplink control channel data distribution values associated with one or more UEs 904 and/or one or more actual uplink control channel data distribution values associated with one or more UEs 904). In some aspects, the network entity 902 may transmit one or more uplink control channel data distribution values to the server 906. For example, the network entity 902 may transmit one or more estimated uplink control channel data distribution values calculated by the network entity 902 and/or may transmit one or more actual uplink control channel data control channel data distribution values calculated by one or more UEs 904. In some aspects, with respect to a given uplink control channel data distribution value transmitted to the server 906, the network entity 902 may provide information indicating a set of conditions associated with the given uplink control channel data distribution value. That is, in some aspects, a communication including a given uplink control channel data distribution value may indicate one or more conditions associated with the uplink control channel data distribution value (e.g., one or more conditions of the UE 904 during a time window associated with an actual uplink control channel data distribution value calculated by the UE 904, one or more conditions of the UE 904 during a time window associated with an estimated uplink control channel data distribution value calculated by the network entity 902). Thus, a given uplink control channel data distribution value can be associated with one or more conditions within the uplink control channel data distribution dataset. As shown at reference 918, the server 906 may store the uplink control channel data distribution dataset.

In this way, the server 906 (or network entity 902) may obtain the uplink control channel data distribution dataset associated with the one or more UEs 904. That is, the server 906 (or the network entity 902) may obtain (e.g., build) a database comprising uplink control channel data distribution values associated with a plurality of UEs 904 experiencing a variety of conditions. In some aspects, the server 906 (or the network entity 902) may store the uplink control channel data distribution dataset with respect to one or more conditions. For example, the server 906 (or the network entity 902) may store the uplink control channel data distribution dataset such that uplink control channel data distribution values associated with a given cell, beam, network-side condition, channel characteristic, UE type, UE category, or combination thereof, can be retrieved from the uplink control channel data distribution dataset.

In some aspects, the uplink control channel data distribution dataset can be used to determine an expected uplink control channel data distribution value (e.g., an expected HARQ-ACK data distribution value) for a UE 904. An expected uplink control channel data distribution value may be, for example, an uplink control channel data distribution value for the UE 904, with the uplink control channel data distribution value being predicted based at least in part on the uplink control channel data distribution dataset. For example, a UE 904 may be store or have access to a model that performs encoding of uplink control channel data based on an uplink control channel data distribution value (e.g., a model that receives an uplink control channel data distribution value as input and provides encoded uplink control channel data as output). In some such aspects, the UE 904 may be provided with an expected (e.g., predicted) uplink control channel data distribution value. In this way, a need for the UE 904 to calculate an uplink control channel data distribution value is avoided, thereby reducing complexity at the UE 904 and providing power savings.

In some aspects, the expected uplink control channel data distribution value may be based at least in part on a set of current conditions associated with the UE 904. The set of current conditions may include, for example, a current beam associated with communication of uplink control channel data by the UE 904, a current cell associated with the communication of the uplink control channel data by the UE 904, a current channel characteristic associated with the communication of the uplink control channel data by the UE 904 (e.g., an SNR), a current network-side condition associated with the communication of the uplink control channel data by the UE 904, a UE type of the UE 904, or a UE category of the UE 904, among other examples. In general, the one or more current conditions include one or more conditions associated with the UE 904 at a point in time for which an expected uplink control channel data distribution value is to be determined.

In some aspects, as shown at reference 920, the network entity 902 may determine the set of current conditions of the UE 904. For example, the UE 904 may transmit, to the network entity 902, a communication indicating one or more current conditions of the UE 904 at a given time. Additionally or alternatively, the network entity 902 may detect one or more current conditions associated with the UE 904 or may otherwise determine one or more current conditions associated with the UE 904 (e.g., based at least in part on a configuration of the UE 904 as provided by the network entity 902).

As shown at reference 922, the network entity 902 may determine the expected uplink control channel data distribution value. For example, the network entity 902 may transmit, to the server 906, a communication including information that indicates the set of current conditions associated with the UE 904. In some aspects, the server 906 may be configured with a model that receives a set of current conditions as input and provides an expected uplink control channel data distribution value as output. That is, the server 906 may be configured with a capability that enables the server 906 to predict an uplink control channel data distribution value for a UE 904 based on a set of current conditions associated with the UE 904. In some such aspects, the server 906 may receive the information that indicates the set of current conditions, and may determine the expected uplink control channel data distribution value accordingly. The server 906 may then transmit the expected uplink control channel data distribution value to the network entity 902.

As shown at reference 924, the network entity 902 may transmit, to the UE 904, the expected uplink control channel data distribution value or a configuration associated with the expected uplink control channel data distribution value. In this way, the UE 904 may be provided with an expected (predicted) uplink control channel data distribution value (or a configuration that is based on the expected uplink control channel data distribution value). In some aspects, the UE 904 can then use the expected uplink control channel data distribution value (or the configuration associated with the expected uplink control channel data distribution value) with respect to a model for encoding uplink control channel data based on a uplink control channel data distribution value (e.g., a HARQ-ACK data distribution value). For example, the UE 904 may determine whether to use the model for encoding uplink control channel data based on the expected uplink control channel data distribution value (or the configuration associated with the expected uplink control channel data distribution value). As another example, the UE 904 may perform one or more operations associated with using a model based at least in part on the expected uplink control channel data distribution value (or the configuration associated with the expected uplink control channel data distribution value). As noted above, determination of the expected uplink control channel data distribution value by the network entity 902 or the server 906 (rather than by the UE 904) may reduce complexity at the UE 904 and/or may increase power savings at the UE 904, while providing consistency with respect to model usage.

In some aspects, the techniques for consistency between model training and usage for uplink control channel data encoding described with respect to the example 900 may enable improved wireless communications performance, such as improved reliability with respect to uplink control channel communications, reduced complexity at a network entity, or improved power efficiency with respect to transmission of uplink control channel data. The improved reliability, reduced complexity at the network entity, and the improved power efficiency may be attributable to the techniques and apparatuses described with respect to the techniques and apparatuses depicted and described with respect to the example 900, for example, due to the network control of scenarios in which a UE 904 is permitted to train or use a model for encoding uplink control channel data.

Note that the process flow illustrated in FIG. 9 is an example of consistency between model training and usage for uplink control channel data encoding, and aspects of the present disclosure may be applied to consistency between model training and usage for uplink control channel data encoding. Note that the process flow illustrated in FIG. 9 is described herein to facilitate an understanding of consistency between model training and usage for uplink control channel data encoding, and aspects of the present disclosure may be performed in various manners via alternative or additional signaling and/or operations. In certain aspects, the operations and/or signaling of FIG. 9 may occur in an order different from that described or depicted, and various actions, operations, and/or signaling may be added, omitted, or combined.

### Example Operations of a User Equipment

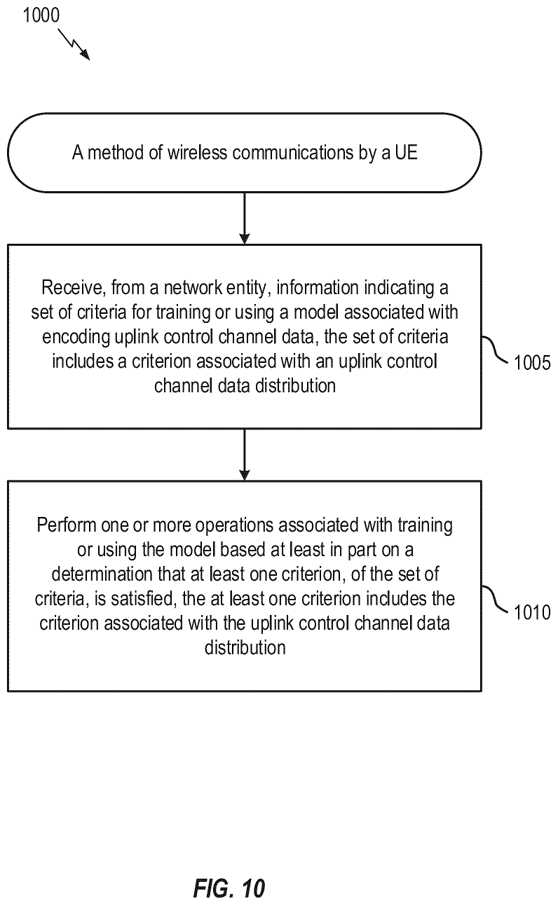

FIG. 10 shows a method 1000 for wireless communications by a UE, such as UE 104 of FIG. 1, UE 304 of FIG. 3, or a UE 804 of FIG. 8.

Method 1000 begins at block 1005 with receiving, from a network entity, information indicating a set of criteria for training or using a model associated with encoding uplink control channel data, wherein the set of criteria includes a criterion associated with an uplink control channel data distribution. For example, the UE 804 may receive, from the network entity 802, information indicating a set of criteria for training or using a model associated with encoding uplink control channel data, as depicted and described with respect to reference 810 of FIG. 8.

Method 1000 then proceeds to block 1010 with performing one or more operations associated with training or using the model based at least in part on a determination that at least one criterion, of the set of criteria, is satisfied, wherein the at least one criterion includes the criterion associated with the uplink control channel data distribution. For example, the UE 804 may perform one or more operations associated with training the model (e.g., as depicted and described with respect to references 814 and 816 of FIG. 8) or using the model (e.g., as depicted and described with respect to reference 816 of FIG. 8).

In some aspects, the uplink control channel data distribution is a HARQ-ACK data distribution.

In some aspects, the set of criteria is in at least one of system information, a RRC message, a MAC CE, or DCI.

In some aspects, the set of criteria includes at least one of: a criterion associated with a physical position of the UE in a cell, a criterion associated with a connection of the UE to one or more particular cells, a criterion associated with a connection of the UE to one or more particular beams on a set of cells, or a criterion associated with a configuration of a network entity.

In some aspects, block 1010 includes: obtaining training data associated with training the model, and transmitting the training data and an indication of the at least one criterion.

In some aspects, block 1010 includes obtaining the model or a set of parameter values associated with the model.

In some aspects, method 1000 further includes transmitting an indication that the at least one criterion is satisfied, and receiving an inference configuration that includes a set of parameter values associated with the model.

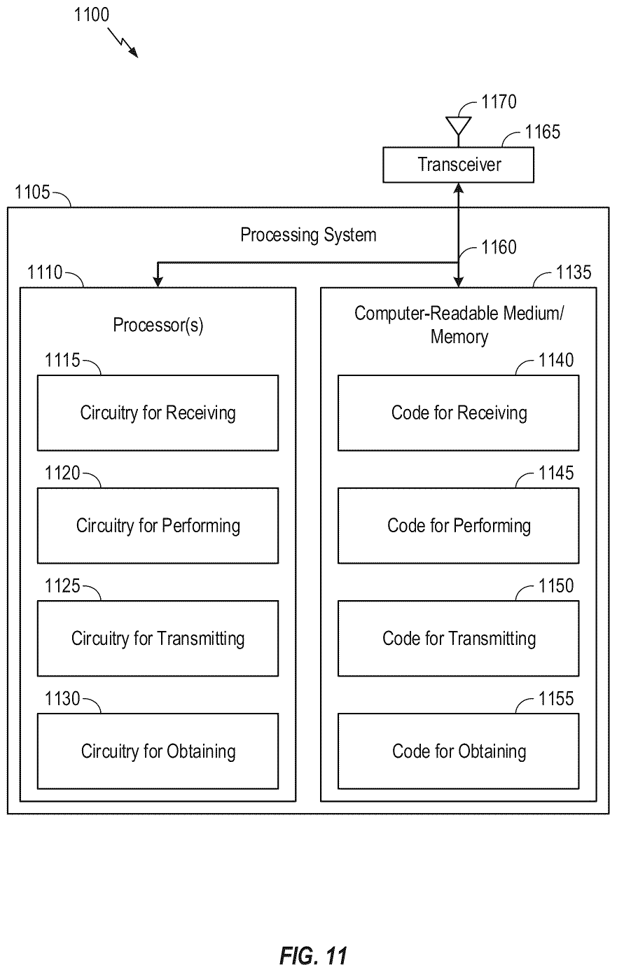

In some aspects, method 1000, or any aspect related to it, may be performed by an apparatus, such as communications device 1100 of FIG. 11, which includes various components operable, configured, or adapted to perform the method 1000. Communications device 1100 is described below in further detail.

In some aspects, the techniques for consistency between model training and usage for uplink control channel data encoding described with respect to the method 1000 may enable improved wireless communications performance, such as improved reliability with respect to uplink control channel communications, reduced complexity at a network entity, or improved power efficiency with respect to transmission of uplink control channel data. The improved reliability, reduced complexity at the network entity, and the improved power efficiency may be attributable to the techniques and apparatuses described with respect to the method 1000, for example, due to the network control of scenarios in which a UE is permitted to train or use a model for encoding uplink control channel data.

Note that FIG. 10 is just one example of a method, and other methods including fewer, additional, or alternative operations are possible consistent with this disclosure.

### Example Communications Device

FIG. 11 depicts aspects of an example communications device 1100 configured for wireless communications. In some aspects, communications device 1100 is a user equipment, such as UE 104 described above with respect to FIG. 1, UE 304 described with respect to FIG. 3, or a UE 804 as discussed with respect to FIG. 8.

The communications device 1100 includes a processing system 1105 coupled to a transceiver 1165 (e.g., a transmitter and/or a receiver). The transceiver 1165 is configured to transmit and receive signals for the communications device 1100 via an antenna 1170, such as the various signals as described herein. The processing system 1105 may be configured to perform processing functions for the communications device 1100, including processing signals received and/or to be transmitted by the communications device 1100.

The processing system 1105 includes one or more processors 1110 and a computer-readable medium/memory 1135. In various aspects, the one or more processors 1110 may be representative of the one or more processors 318 described with respect to FIG. 3. The one or more processors 1110 are coupled to a computer-readable medium/memory 1135 via a bus 1160. In some aspects, the computer-readable medium/memory 1135 may be representative of the one or more memories 320 described with respect to FIG. 3. The computer-readable medium/memory 1135 is a non-transitory computer-readable medium/memory. In certain aspects, the computer-readable medium/memory 1135 is configured to store instructions (e.g., computer-executable code), that when executed by the one or more processors 1110, cause the one or more processors 1110 to perform the method 1000 described with respect to FIG. 10, or any aspect related to it, including any operations described in relation to FIG. 10. Note that reference to a processor performing a function of communications device 1100 may include one or more processors performing that function of communications device 1100, such as in a distributed fashion.

In the depicted example, computer-readable medium/memory 1135 stores code (e.g., executable instructions), including code for receiving 1140, code for performing 1145, code for transmitting 1150, and code for obtaining 1155. Processing of the code 1140-1155 may enable and cause the communications device 1100 to perform the method 1000 described with respect to FIG. 10, or any aspect related to it. For instance, in some aspects, code for receiving 1140 includes code for receiving, from a network entity, information indicating a set of criteria for training or using a model associated with encoding uplink control channel data, wherein the set of criteria includes a criterion associated with an uplink control channel data distribution. In some aspects, code for performing 1145 includes code for performing one or more operations associated with training or using the model based at least in part on a determination that at least one criterion, of the set of criteria, is satisfied, wherein the at least one criterion includes the criterion associated with the uplink control channel data distribution.

The one or more processors 1110 include circuitry configured to implement (e.g., execute) the code stored in the computer-readable medium/memory 1135, including circuitry for receiving 1115, circuitry for performing 1120, circuitry for transmitting 1125, and circuitry for obtaining 1130. Processing with circuitry 1115-1130 may enable and cause the communications device 1100 to perform the method 1000 described with respect to FIG. 10, or any aspect related to it. For instance, in some aspects, circuitry for receiving 1115 includes circuitry for receiving, from a network entity, information indicating a set of criteria for training or using a model associated with encoding uplink control channel data, wherein the set of criteria includes a criterion associated with an uplink control channel data distribution. In some aspects, circuitry for performing 1120 includes circuitry for performing one or more operations associated with training or using the model based at least in part on a determination that at least one criterion, of the set of criteria, is satisfied, wherein the at least one criterion includes the criterion associated with the uplink control channel data distribution.

More generally, means for communicating, transmitting, sending or outputting for transmission may include the one or more transceivers 324, one or more antenna 322 and/or processing system 316 of the UE 304 illustrated in FIG. 3, transceiver 1165 and/or antenna 1170 of the communications device 1100 in FIG. 11, and/or one or more processors 1110 of the communications device 1100 in FIG. 11. Means for communicating, receiving or obtaining may include the one or more transceivers 324, one or more antennas 322, and/or processing system 316 of the UE 304 illustrated in FIG. 3, transceiver 1165 and/or antenna 1170 of the communications device 1100 in FIG. 11, and/or one or more processors 1110 of the communications device 1100 in FIG. 11.

### Example Operations of a Network Entity

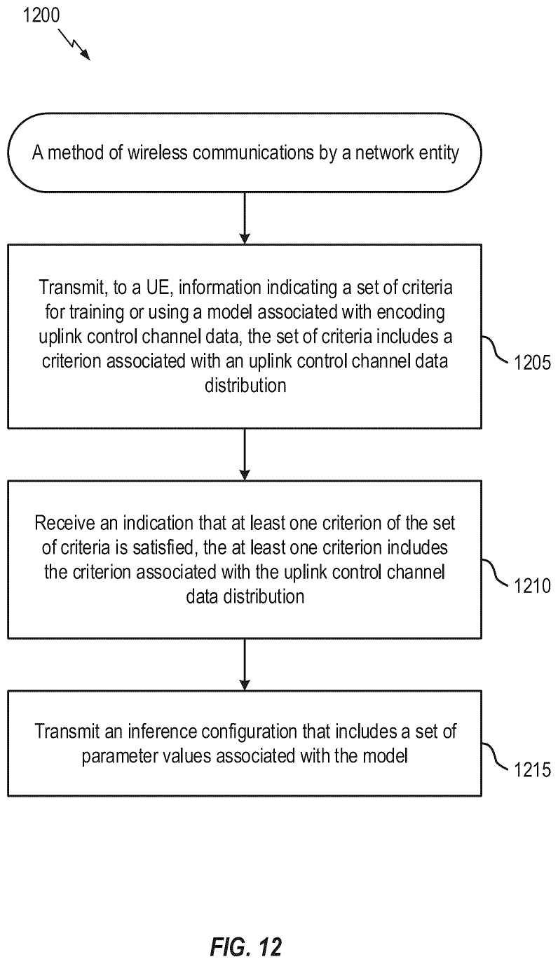

FIG. 12 shows a method 1200 for wireless communications by a network entity, such as BS 102 of FIG. 1, a first network entity 300 or second network entity 302 of FIG. 3, a disaggregated base station as discussed with respect to FIG. 2, or a network entity 802 or server 806 as discussed with respect to FIG. 8.

Method 1200 begins at block 1205 with transmitting, to a UE, information indicating a set of criteria for training or using a model associated with encoding uplink control channel data, wherein the set of criteria includes a criterion associated with an uplink control channel data distribution. For example, a network entity 802 may transmit, to a UE 804, information indicating a set of criteria for training or using a model associated with encoding uplink control channel data, as depicted and described with respect to reference 810 of FIG. 8.

Method 1200 then proceeds to block 1210 with receiving an indication that at least one criterion of the set of criteria is satisfied, wherein the at least one criterion includes the criterion associated with the uplink control channel data distribution. For example, the network entity 802 may receive an indication that at least one criterion of the set of criteria is satisfied, as depicted and described with respect to reference 820 of FIG. 8.

Method 1200 then proceeds to block 1215 with transmitting an inference configuration that includes a set of parameter values associated with the model. For example, the network entity 802 may transmit an inference configuration that includes a set of parameter values associated with the model, as depicted and described with respect to reference 822 of FIG. 8.

In some aspects, the uplink control channel data distribution is a HARQ-ACK data distribution.

In some aspects, the set of criteria is in at least one of system information, a RRC message, a MAC CE, or DCI.

In some aspects, the set of criteria includes at least one of: a criterion associated with a physical position of the UE in a cell, a criterion associated with a connection of the UE to one or more particular cells, a criterion associated with a connection of the UE to one or more particular beams on a set of cells, or a criterion associated with a configuration of a network entity.

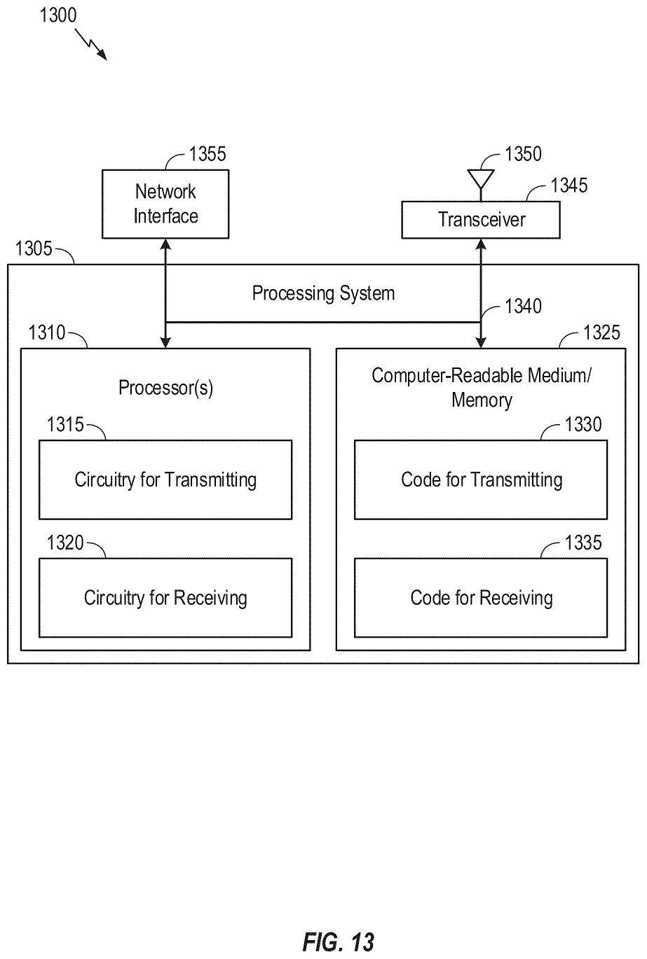

In some aspects, method 1200, or any aspect related to it, may be performed by an apparatus, such as communications device 1300 of FIG. 13, which includes various components operable, configured, or adapted to perform the method 1200. Communications device 1300 is described below in further detail.

In some aspects, the techniques for consistency between model training and usage for uplink control channel data encoding described with respect to the method 1200 may enable improved wireless communications performance, such as improved reliability with respect to uplink control channel communications, reduced complexity at a network entity, or improved power efficiency with respect to transmission of uplink control channel data. The improved reliability, reduced complexity at the network entity, and the improved power efficiency may be attributable to the techniques and apparatuses described with respect to the method 1200, for example, due to the network control of scenarios in which a UE is permitted to train or use a model for encoding uplink control channel data.

Note that FIG. 12 is just one example of a method, and other methods including fewer, additional, or alternative operations are possible consistent with this disclosure.

### Example Communications Device

FIG. 13 depicts aspects of an example communications device configured for wireless communications. In some aspects, communications device 1300 is a network entity, such as BS 102 of FIG. 1, first network entity 300 or second network entity 302 of FIG. 3, a disaggregated base station as discussed with respect to FIG. 2, or a network entity 802 or a server 806 of FIG. 8.

The communications device 1300 includes a processing system 1305 coupled to a transceiver 1345 (e.g., a transmitter and/or a receiver) and/or a network interface 1355. The transceiver 1345 is configured to transmit and receive signals for the communications device 1300 via an antenna 1350, such as the various signals as described herein. The network interface 1355 is configured to obtain and send signals for the communications device 1300 via communications link(s), such as a backhaul link, midhaul link, and/or fronthaul link as described herein, such as with respect to FIG. 2. The processing system 1305 may be configured to perform processing functions for the communications device 1300, including processing signals received and/or to be transmitted by the communications device 1300.

The processing system 1305 includes one or more processors 1310 and a computer-readable medium/memory 1325. In various aspects, one or more processors 1310 may be representative of the one or more processors 308, as described with respect to FIG. 3. The one or more processors 1310 are coupled to the computer-readable medium/memory 1325 via a bus 1340. In certain aspects, the computer-readable medium/memory 1325 is configured to store instructions (e.g., computer-executable code), including code 1330 and 1335, that when executed by the one or more processors 1310, cause the one or more processors 1310 to perform the method 1200 described with respect to FIG. 12, or any aspect related to it, including any operations described in relation to FIG. 12. The computer-readable medium/memory 1325 is a non-transitory computer-readable medium/memory. Note that reference to a processor of communications device 1300 performing a function may include one or more processors of communications device 1300 performing that function, such as in a distributed fashion.

In the depicted example, the computer-readable medium/memory 1325 stores code (e.g., executable instructions), including code for transmitting 1330 and code for receiving 1335. Processing of the code 1330 and 1335 may enable and cause the communications device 1300 to perform the method 1200 described with respect to FIG. 12, or any aspect related to it. For instance, in some aspects, code for transmitting 1330 includes code for transmitting, to a UE, information indicating a set of criteria for training or using a model associated with encoding uplink control channel data, wherein the set of criteria includes a criterion associated with an uplink control channel data distribution. In some aspects, code for receiving 1335 includes code for receiving an indication that at least one criterion of the set of criteria is satisfied, wherein the at least one criterion includes the criterion associated with the uplink control channel data distribution. In some aspects, code for transmitting 1330 includes code for transmitting an inference configuration that includes a set of parameter values associated with the model.

The one or more processors 1310 include circuitry configured to implement (e.g., execute) the code stored in the computer-readable medium/memory 1325, including circuitry for transmitting 1315 and circuitry for receiving 1320. Processing with circuitry 1315 and 1320 may enable and cause the communications device 1300 to perform the method 1200 described with respect to FIG. 12, or any aspect related to it. For instance, in some aspects, circuitry for transmitting 1315 includes circuitry for transmitting, to a UE, information indicating a set of criteria for training or using a model associated with encoding uplink control channel data, wherein the set of criteria includes a criterion associated with an uplink control channel data distribution. In some aspects, circuitry for receiving 1320 includes circuitry for receiving an indication that at least one criterion of the set of criteria is satisfied, wherein the at least one criterion includes the criterion associated with the uplink control channel data distribution. In some aspects, circuitry for transmitting 1315 includes circuitry for transmitting an inference configuration that includes a set of parameter values associated with the model.

Various components of the communications device 1300 may provide means for performing the method 1200 described with respect to FIG. 12, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1345, antenna 1350, and/or network interface 1355 of the communications device 1300 in FIG. 13, and/or one or more processors 1310 of the communications device 1300 in FIG. 13. Means for communicating, receiving or obtaining may include the one or more transceivers 312, one or more antennas 314, and/or processing system 306 of the first network entity 300 or the second network entity 302 illustrated in FIG. 3, transceiver 1345, antenna 1350, and/or network interface 1355 of the communications device 1300 in FIG. 13, and/or one or more processors 1310 of the communications device 1300 in FIG. 13.

### Example Operations of a Network Entity

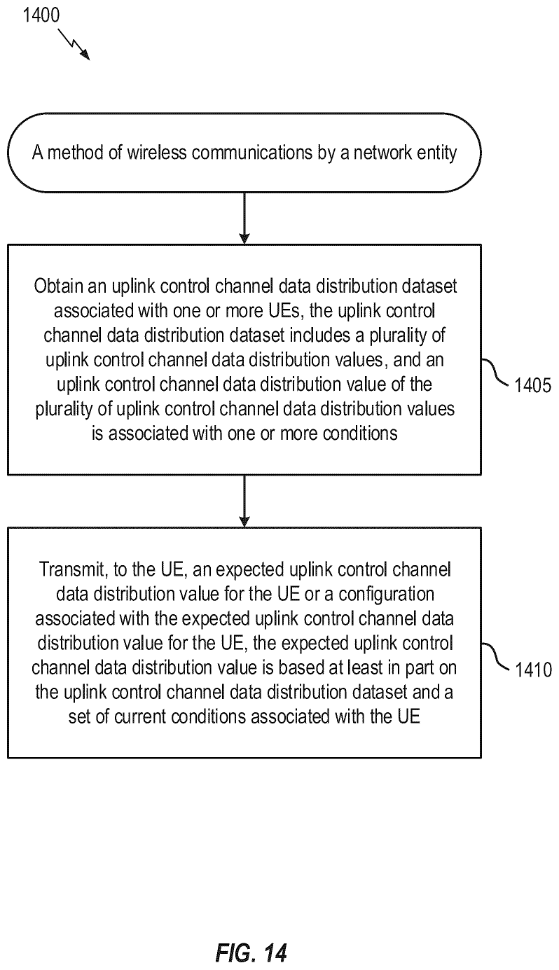

FIG. 14 shows a method 1400 for wireless communications by a network entity, such as BS 102 of FIG. 1, a first network entity 300 or second network entity 302 of FIG. 3, a disaggregated base station as discussed with respect to FIG. 2, or a network entity 902 or server 906 as discussed with respect to FIG. 9.

Method 1400 begins at block 1405 with obtaining an uplink control channel data distribution dataset associated with one or more UEs, wherein the uplink control channel data distribution dataset includes a plurality of uplink control channel data distribution values, and an uplink control channel data distribution value of the plurality of uplink control channel data distribution values is associated with one or more conditions. For example, a server 906 (or a network entity 802 may obtain an uplink control channel data distribution dataset associated with one or more UEs 904, as depicted and described with respect to references 914 of FIG. 9.

Method 1400 then proceeds to block 1410 with transmitting, to the UE, an expected uplink control channel data distribution value for the UE or a configuration associated with the expected uplink control channel data distribution value for the UE, wherein the expected uplink control channel data distribution value is based at least in part on the uplink control channel data distribution dataset and a set of current conditions associated with the UE. For example, the network entity 902 may transmit, to a UE 904, an expected uplink control channel data distribution value for the UE 904, as depicted and described with respect to reference 922 of FIG. 9.

In some aspects, the uplink control channel data distribution value is a HARQ-ACK data distribution value.

In some aspects, the one or more conditions include at least one of: a beam associated with communication of uplink control channel data, a cell associated with the communication of the uplink control channel data, a channel characteristic associated with the communication of the uplink control channel data, a network side condition associated with the communication of the uplink control channel data, a UE type, or a UE category.

In some aspects, the expected uplink control channel data distribution value is an expected HARQ-ACK data distribution value.

In some aspects, the set of current conditions associated with the UE includes at least one of: a current beam associated with communication of uplink control channel data, a current cell associated with the communication of the uplink control channel data, a current channel characteristic associated with the communication of the uplink control channel data, a current network side condition associated with the communication of the uplink control channel data, a UE type of the UE, or a UE category of the UE.

In some aspects, block 1405 includes calculating one or more estimated uplink control channel data distribution values, associated with at least one UE of the one or more UEs, based at least in part on an uplink control channel data distribution reporting configuration.

In some aspects, block 1405 includes: transmitting, to at least one UE of the plurality of UEs, an uplink control channel data distribution value reporting configuration; and receiving, from the at least one UE and in accordance with the uplink control channel data distribution value reporting configuration, a communication indicating an actual uplink control channel data distribution value associated with the at least one UE.

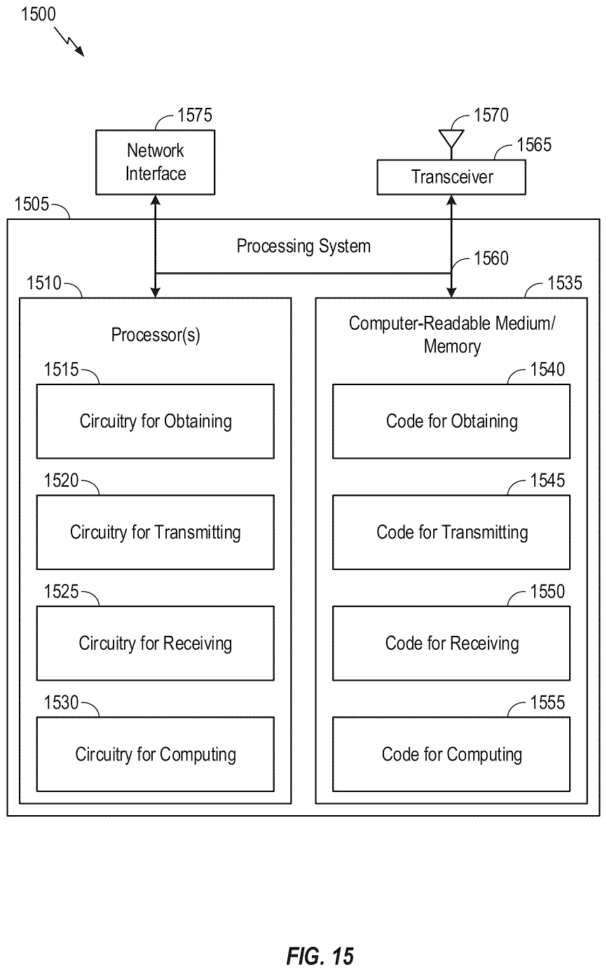

In some aspects, method 1400, or any aspect related to it, may be performed by an apparatus, such as communications device 1500 of FIG. 15, which includes various components operable, configured, or adapted to perform the method 1400. Communications device 1500 is described below in further detail.

In some aspects, the techniques for consistency between model training and usage for uplink control channel data encoding described with respect to the method 1400 may enable improved wireless communications performance, such as improved reliability with respect to uplink control channel communications, reduced complexity at a network entity, or improved power efficiency with respect to transmission of uplink control channel data. The improved reliability, reduced complexity at the network entity, and the improved power efficiency may be attributable to the techniques and apparatuses described with respect to the method 1400, for example, due to the network control of scenarios in which a UE is permitted to train or use a model for encoding uplink control channel data.

Note that FIG. 14 is just one example of a method, and other methods including fewer, additional, or alternative operations are possible consistent with this disclosure.

### Example Communications Device

FIG. 15 depicts aspects of an example communications device configured for wireless communications. In some aspects, communications device 1500 is a network entity, such as BS 102 of FIG. 1, first network entity 300 or second network entity 302 of FIG. 3, a disaggregated base station as discussed with respect to FIG. 2, or a network entity 902 or data storage device 906 as discussed with respect to FIG. 9.

The communications device 1500 includes a processing system 1505 coupled to a transceiver 1565 (e.g., a transmitter and/or a receiver) and/or a network interface 1575. The transceiver 1565 is configured to transmit and receive signals for the communications device 1500 via an antenna 1570, such as the various signals as described herein. The network interface 1575 is configured to obtain and send signals for the communications device 1500 via communications link(s), such as a backhaul link, midhaul link, and/or fronthaul link as described herein, such as with respect to FIG. 2. The processing system 1505 may be configured to perform processing functions for the communications device 1500, including processing signals received and/or to be transmitted by the communications device 1500.

The processing system 1505 includes one or more processors 1510 and a computer-readable medium/memory 1535. In various aspects, one or more processors 1510 may be representative of the one or more processors 308, as described with respect to FIG. 3. The one or more processors 1510 are coupled to the computer-readable medium/memory 1535 via a bus 1560. In certain aspects, the computer-readable medium/memory 1535 is configured to store instructions (e.g., computer-executable code), including code 1540-1555, that when executed by the one or more processors 1510, cause the one or more processors 1510 to perform the method 1400 described with respect to FIG. 14, or any aspect related to it, including any operations described in relation to FIG. 14. The computer-readable medium/memory 1535 is a non-transitory computer-readable medium/memory. Note that reference to a processor of communications device 1500 performing a function may include one or more processors of communications device 1500 performing that function, such as in a distributed fashion.

In the depicted example, the computer-readable medium/memory 1535 stores code (e.g., executable instructions), including code for obtaining 1540, code for transmitting 1545, code for receiving 1550, and code for computing 1555. Processing of the code 1540-1555 may enable and cause the communications device 1500 to perform the method 1400 described with respect to FIG. 14, or any aspect related to it. For instance, in some aspects, code for obtaining 1540 includes code for obtaining an uplink control channel data distribution dataset associated with one or more UEs, wherein: the uplink control channel data distribution dataset includes a plurality of uplink control channel data distribution values and an uplink control channel data distribution value of the plurality of uplink control channel data distribution values is associated with one or more conditions. In some aspects, code for transmitting 1545 includes code for transmitting, to the UE, an expected uplink control channel data distribution value for the UE or a configuration associated with the expected uplink control channel data distribution value for the UE, wherein the expected uplink control channel data distribution value is based at least in part on the uplink control channel data distribution dataset and a set of current conditions associated with the UE.

The one or more processors 1510 include circuitry configured to implement (e.g., execute) the code stored in the computer-readable medium/memory 1535, including circuitry for obtaining 1515, circuitry for transmitting 1520, circuitry for receiving 1525, and circuitry for computing 1530. Processing with circuitry 1515-1530 may enable and cause the communications device 1500 to perform the method 1400 described with respect to FIG. 14, or any aspect related to it. For instance, in some aspects, circuitry for obtaining 1515 includes circuitry for obtaining an uplink control channel data distribution dataset associated with one or more UEs, wherein: the uplink control channel data distribution dataset includes a plurality of uplink control channel data distribution values and an uplink control channel data distribution value of the plurality of uplink control channel data distribution values is associated with one or more conditions. In some aspects, circuitry for transmitting 1520 includes circuitry for transmitting, to the UE, an expected uplink control channel data distribution value for the UE or a configuration associated with the expected uplink control channel data distribution value for the UE, wherein the expected uplink control channel data distribution value is based at least in part on the uplink control channel data distribution dataset and a set of current conditions associated with the UE.

Various components of the communications device 1500 may provide means for performing the method 1400 described with respect to FIG. 14, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1565, antenna 1570, and/or network interface 1575 of the communications device 1500 in FIG. 15, and/or one or more processors 1510 of the communications device 1500 in FIG. 15. Means for communicating, receiving or obtaining may include the one or more transceivers 312, one or more antennas 314, and/or processing system 306 of the first network entity 300 or the second network entity 302 illustrated in FIG. 3, transceiver 1565, antenna 1570, and/or network interface 1575 of the communications device 1500 in FIG. 15, and/or one or more processors 1510 of the communications device 1500 in FIG. 15.

### Example Operations of a User Equipment

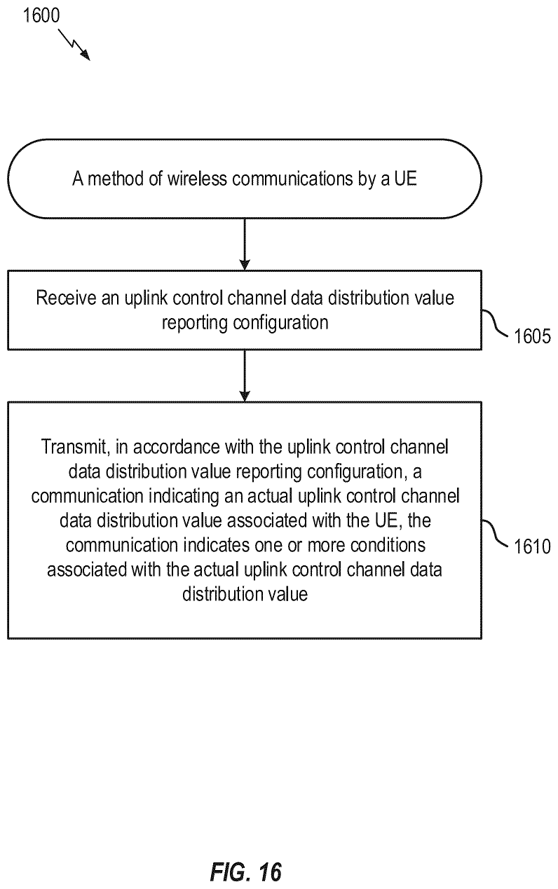

FIG. 16 shows a method 1600 for wireless communications by a UE, such as UE 104 of FIG. 1, UE 304 of FIG. 3, or a UE 904 of FIG. 9.

Method 1600 begins at block 1605 with receiving an uplink control channel data distribution value reporting configuration. For example, a UE 904 may receive an uplink control channel data distribution value reporting configuration, as depicted and described with respect to reference 912 of FIG. 9.

Method 1600 then proceeds to block 1610 with transmitting, in accordance with the uplink control channel data distribution value reporting configuration, a communication indicating an actual uplink control channel data distribution value associated with the UE, wherein the communication indicates one or more conditions associated with the actual uplink control channel data distribution value. For example, the UE 904 may transmit, in accordance with the uplink control channel data distribution value reporting configuration, a communication indicating an actual uplink control channel data distribution value associated with the UE 904, as depicted and described with respect to reference 914 of FIG. 9.

In some aspects, method 1600 further includes receiving an expected uplink control channel data distribution value or a configuration associated with the expected uplink control channel data distribution value. For example, the UE 904 may receive an expected uplink control channel data distribution value or a configuration associated with the expected uplink control channel data distribution value, as depicted and described with respect to reference 922 of FIG. 9.

In some aspects, method 1600 further includes performing one or more operations associated with using a model based at least in part on the expected uplink control channel data distribution value or the configuration associated with the expected uplink control channel data distribution value. For example, the UE 904 may perform one or more operations associated with using a model based at least in part on the expected uplink control channel data distribution value, as described above with respect to FIG. 9.

In some aspects, the expected uplink control channel data distribution value is an expected HARQ-ACK data distribution value.

In some aspects, the actual uplink control channel data distribution value is an actual HARQ-ACK data distribution value.

In some aspects, the one or more conditions associated with the UE include at least one of: a beam associated with communication of uplink control channel data, a cell associated with the communication of the uplink control channel data, a channel characteristic associated with the communication of the uplink control channel data, a network side condition associated with the communication of the uplink control channel data, a UE type of the UE, or a UE category of the UE.

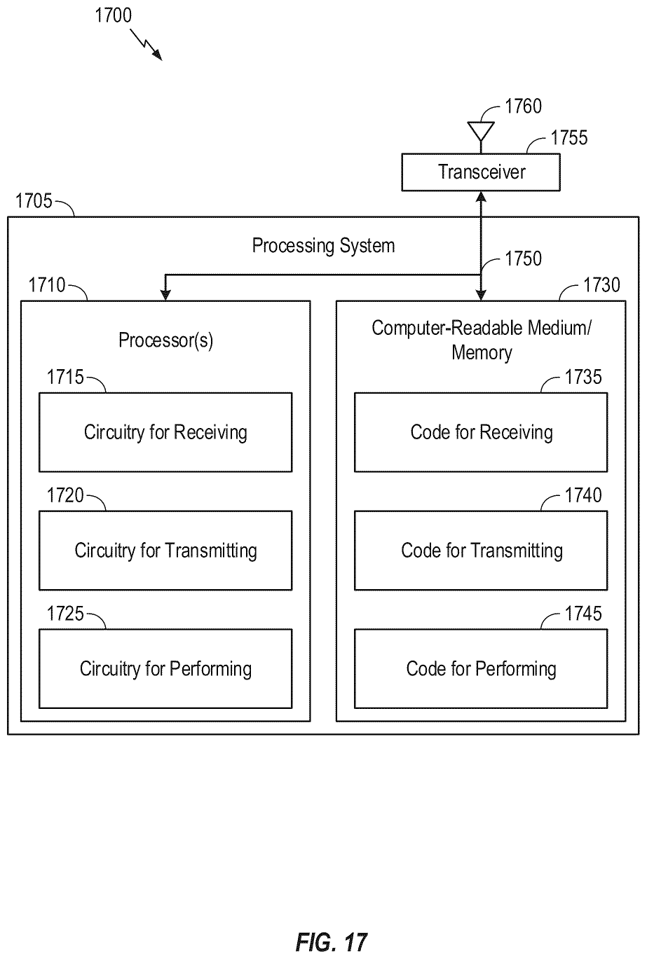

In some aspects, method 1600, or any aspect related to it, may be performed by an apparatus, such as communications device 1700 of FIG. 17, which includes various components operable, configured, or adapted to perform the method 1600. Communications device 1700 is described below in further detail.

In some aspects, the techniques for consistency between model training and usage for uplink control channel data encoding described with respect to the method 1600 may enable improved wireless communications performance, such as improved reliability with respect to uplink control channel communications, reduced complexity at a network entity, or improved power efficiency with respect to transmission of uplink control channel data. The improved reliability, reduced complexity at the network entity, and the improved power efficiency may be attributable to the techniques and apparatuses described with respect to the method 1600, for example, due to the network control of scenarios in which a UE is permitted to train or use a model for encoding uplink control channel data.

Note that FIG. 16 is just one example of a method, and other methods including fewer, additional, or alternative operations are possible consistent with this disclosure.

### Example Communications Device

FIG. 17 depicts aspects of an example communications device 1700 configured for wireless communications. In some aspects, communications device 1700 is a user equipment, such as UE 104 described above with respect to FIG. 1, UE 304 described with respect to FIG. 3, or a UE 904 as discussed with respect to FIG. 9.

The communications device 1700 includes a processing system 1705 coupled to a transceiver 1755 (e.g., a transmitter and/or a receiver). The transceiver 1755 is configured to transmit and receive signals for the communications device 1700 via an antenna 1760, such as the various signals as described herein. The processing system 1705 may be configured to perform processing functions for the communications device 1700, including processing signals received and/or to be transmitted by the communications device 1700.

The processing system 1705 includes one or more processors 1710 and a computer-readable medium/memory 1730. In various aspects, the one or more processors 1710 may be representative of the one or more processors 318 described with respect to FIG. 3. The one or more processors 1710 are coupled to a computer-readable medium/memory 1730 via a bus 1750. In some aspects, the computer-readable medium/memory 1730 may be representative of the one or more memories 320 described with respect to FIG. 3. The computer-readable medium/memory 1730 is a non-transitory computer-readable medium/memory. In certain aspects, the computer-readable medium/memory 1730 is configured to store instructions (e.g., computer-executable code), that when executed by the one or more processors 1710, cause the one or more processors 1710 to perform the method 1600 described with respect to FIG. 16, or any aspect related to it, including any operations described in relation to FIG. 16. Note that reference to a processor performing a function of communications device 1700 may include one or more processors performing that function of communications device 1700, such as in a distributed fashion.

In the depicted example, computer-readable medium/memory 1730 stores code (e.g., executable instructions), including code for receiving 1735, code for transmitting 1740, and code for performing 1745. Processing of the code 1735-1745 may enable and cause the communications device 1700 to perform the method 1600 described with respect to FIG. 16, or any aspect related to it. For instance, in some aspects, code for receiving 1735 includes code for receiving an uplink control channel data distribution value reporting configuration. In some aspects, code for transmitting 1740 includes code for transmitting, in accordance with the uplink control channel data distribution value reporting configuration, a communication indicating an actual uplink control channel data distribution value associated with the UE, wherein the communication indicates one or more conditions associated with the actual uplink control channel data distribution value.

The one or more processors 1710 include circuitry configured to implement (e.g., execute) the code stored in the computer-readable medium/memory 1730, including circuitry for receiving 1715, circuitry for transmitting 1720, and circuitry for performing 1725. Processing with circuitry 1715-1725 may enable and cause the communications device 1700 to perform the method 1600 described with respect to FIG. 16, or any aspect related to it. For instance, in some aspects, circuitry for receiving 1715 includes circuitry for receiving an uplink control channel data distribution value reporting configuration. In some aspects, circuitry for transmitting 1720 includes circuitry for transmitting, in accordance with the uplink control channel data distribution value reporting configuration, a communication indicating an actual uplink control channel data distribution value associated with the UE, wherein the communication indicates one or more conditions associated with the actual uplink control channel data distribution value.

More generally, means for communicating, transmitting, sending or outputting for transmission may include the one or more transceivers 324, one or more antenna 322 and/or processing system 316 of the UE 304 illustrated in FIG. 3, transceiver 1755 and/or antenna 1760 of the communications device 1700 in FIG. 17, and/or one or more processors 1710 of the communications device 1700 in FIG. 17. Means for communicating, receiving or obtaining may include the one or more transceivers 324, one or more antennas 322, and/or processing system 316 of the UE 304 illustrated in FIG. 3, transceiver 1755 and/or antenna 1760 of the communications device 1700 in FIG. 17, and/or one or more processors 1710 of the communications device 1700 in FIG. 17.

### Example Clauses

Implementation examples are described in the following numbered clauses:

Clause 1: A method of wireless communications by a UE, comprising: receiving, from a network entity, information indicating a set of criteria for training or using a model associated with encoding uplink control channel data, wherein the set of criteria includes a criterion associated with an uplink control channel data distribution; and performing one or more operations associated with training or using the model based at least in part on a determination that at least one criterion, of the set of criteria, is satisfied, wherein the at least one criterion includes the criterion associated with the uplink control channel data distribution.

Clause 2: The method of Clause 1, wherein the uplink control channel data distribution is a HARQ-ACK data distribution.

Clause 3: The method of any one of Clauses 1-2, wherein the set of criteria is in at least one of system information, a RRC message, a MAC CE, or DCI.

Clause 4: The method of any one of Clauses 1-3, wherein the set of criteria includes at least one of: a criterion associated with a physical position of the UE in a cell, a criterion associated with a connection of the UE to one or more particular cells, a criterion associated with a connection of the UE to one or more particular beams on a set of cells, or a criterion associated with a configuration of a network entity.

Clause 5: The method of any one of Clauses 1-4, wherein performing the one or more operations comprises: obtaining training data associated with training the model, and transmitting the training data and an indication of the at least one criterion.

Clause 6: The method of any one of Clauses 1-5, wherein performing the one or more operations comprises obtaining the model or a set of parameter values associated with the model.

Clause 7: The method of any one of Clauses 1-6, further comprising: transmitting an indication that the at least one criterion is satisfied, and receiving an inference configuration that includes a set of parameter values associated with the model.

Clause 8: A method of wireless communications by a network entity, comprising: transmitting, to a UE, information indicating a set of criteria for training or using a model associated with encoding uplink control channel data, wherein the set of criteria includes a criterion associated with an uplink control channel data distribution; receiving an indication that at least one criterion of the set of criteria is satisfied, wherein the at least one criterion includes the criterion associated with the uplink control channel data distribution; and transmitting an inference configuration that includes a set of parameter values associated with the model.

Clause 9: The method of Clause 8, wherein the uplink control channel data distribution is a HARQ-ACK data distribution.

Clause 10: The method of any one of Clauses 8-9, wherein the set of criteria is in at least one of system information, a RRC message, a MAC CE, or DCI.

Clause 11: The method of any one of Clauses 8-10, wherein the set of criteria includes at least one of: a criterion associated with a physical position of the UE in a cell, a criterion associated with a connection of the UE to one or more particular cells, a criterion associated with a connection of the UE to one or more particular beams on a set of cells, or a criterion associated with a configuration of a network entity.

Clause 12: A method of wireless communications by a network entity, comprising: obtaining an uplink control channel data distribution dataset associated with one or more UEs, wherein: the uplink control channel data distribution dataset includes a plurality of uplink control channel data distribution values, and an uplink control channel data distribution value of the plurality of uplink control channel data distribution values is associated with one or more conditions; and transmitting, to the UE, an expected uplink control channel data distribution value for the UE or a configuration associated with the expected uplink control channel data distribution value for the UE, wherein the expected uplink control channel data distribution value is based at least in part on the uplink control channel data distribution dataset and a set of current conditions associated with the UE.

Clause 13: The method of Clause 12, wherein the uplink control channel data distribution value is a HARQ-ACK data distribution value.

Clause 14: The method of any one of Clauses 12-13, wherein the one or more conditions include at least one of: a beam associated with communication of uplink control channel data, a cell associated with the communication of the uplink control channel data, a channel characteristic associated with the communication of the uplink control channel data, a network side condition associated with the communication of the uplink control channel data, a UE type, or a UE category.

Clause 15: The method of any one of Clauses 12-14, wherein the expected uplink control channel data distribution value is an expected HARQ-ACK data distribution value.

Clause 16: The method of any one of Clauses 12-15, wherein the set of current conditions associated with the UE includes at least one of: a current beam associated with communication of uplink control channel data, a current cell associated with the communication of the uplink control channel data, a current channel characteristic associated with the communication of the uplink control channel data, a current network side condition associated with the communication of the uplink control channel data, a UE type of the UE, or a UE category of the UE.

Clause 17: The method of any one of Clauses 12-16, wherein obtaining the uplink control channel data distribution dataset comprises calculating one or more estimated uplink control channel data distribution values, associated with at least one UE of the one or more UEs, based at least in part on an uplink control channel data distribution reporting configuration.

Clause 18: The method of any one of Clauses 12-17, wherein obtaining the uplink control channel data distribution dataset comprises: transmitting, to at least one UE of the plurality of UEs, an uplink control channel data distribution value reporting configuration; and receiving, from the at least one UE and in accordance with the uplink control channel data distribution value reporting configuration, a communication indicating an actual uplink control channel data distribution value associated with the at least one UE.

Clause 19: A method of wireless communications by a UE, comprising: receiving an uplink control channel data distribution value reporting configuration; and transmitting, in accordance with the uplink control channel data distribution value reporting configuration, a communication indicating an actual uplink control channel data distribution value associated with the UE, wherein the communication indicates one or more conditions associated with the actual uplink control channel data distribution value.

Clause 20: The method of Clause 19, further comprising: receiving an expected uplink control channel data distribution value or a configuration associated with the expected uplink control channel data distribution value; and performing one or more operations associated with using a model based at least in part on the expected uplink control channel data distribution value or the configuration associated with the expected uplink control channel data distribution value.

Clause 21: The method of Clause 20, wherein the expected uplink control channel data distribution value is an expected HARQ-ACK data distribution value.

Clause 22: The method of any one of Clauses 19-21, wherein the actual uplink control channel data distribution value is an actual HARQ-ACK data distribution value.

Clause 23: The method of any one of Clauses 19-22, wherein the one or more conditions associated with the UE include at least one of: a beam associated with communication of uplink control channel data, a cell associated with the communication of the uplink control channel data, a channel characteristic associated with the communication of the uplink control channel data, a network side condition associated with the communication of the uplink control channel data, a UE type of the UE, or a UE category of the UE.

Clause 24: One or more apparatuses, comprising: one or more memories comprising executable instructions; and one or more processors configured to execute the executable instructions and cause the one or more apparatuses to perform a method in accordance with any one of Clauses 1-23.

Clause 25: One or more apparatuses configured for wireless communications, comprising: one or more memories; and one or more processors, coupled to the one or more memories, configured to cause the one or more apparatuses to perform a method in accordance with any one of Clauses 1-23.

Clause 26: One or more apparatuses configured for wireless communications, comprising: one or more memories; and one or more processors, coupled to the one or more memories, configured to perform a method in accordance with any one of Clauses 1-23.

Clause 27: One or more apparatuses, comprising means for performing a method in accordance with any one of Clauses 1-23.

Clause 28: One or more non-transitory computer-readable media comprising executable instructions that, when executed by one or more processors of one or more apparatuses, cause the one or more apparatuses to perform a method in accordance with any one of Clauses 1-23.

Clause 29: One or more computer program products embodied on one or more computer-readable storage media comprising code for performing a method in accordance with any one of Clauses 1-23.

Clause 30: One or more apparatuses configured for wireless communications, comprising: a processing system that includes one or more processors and one or more memories coupled with the one or more processors, the processing system configured to cause the one or more apparatuses to perform a method in accordance with any one of Clauses 1-23.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured for wireless communication, comprising a processing system that includes one or more processors and one or more memories coupled with the one or more processors, the processing system configured to cause a user equipment (UE) to:
receive, from a network entity, information indicating a set of criteria for training or using a model associated with encoding uplink control channel data, wherein the set of criteria includes a criterion associated with an uplink control channel data distribution; and
perform one or more operations associated with training or using the model based at least in part on a determination that at least one criterion, of the set of criteria, is satisfied,
wherein the at least one criterion includes the criterion associated with the uplink control channel data distribution.

2. The apparatus of claim 1, wherein the uplink control channel data distribution is a hybrid automatic repeat request acknowledgment (HARQ-ACK) data distribution.

3. The apparatus of claim 1, wherein the set of criteria is in at least one of system information, a radio resource control (RRC) message, a medium access control (MAC) control element (CE), or downlink control information (DCI).

4. The apparatus of claim 1, wherein the set of criteria includes at least one of:
a criterion associated with a physical position of the UE in a cell,
a criterion associated with a connection of the UE to one or more particular cells,
a criterion associated with a connection of the UE to one or more particular beams on a set of cells, or
a criterion associated with a configuration of a network entity.

5. The apparatus of claim 1, wherein to cause the UE to perform the one or more operations, the processing system is configured to cause the UE to:
obtain training data associated with training the model, and
transmit the training data and an indication of the at least one criterion.

6. The apparatus of claim 1, wherein to cause the UE to perform the one or more operations, the processing system is configured to cause the UE to obtain the model or a set of parameter values associated with the model.

7. The apparatus of claim 1, wherein the processing system is further configured to cause the UE to:
transmit an indication that the at least one criterion is satisfied, and
receiving an inference configuration that includes a set of parameter values associated with the model.

8. An apparatus configured for wireless communication, comprising a processing system that includes one or more processors and one or more memories coupled with the one or more processors, the processing system configured to cause a network entity to:
transmit, to a user equipment (UE), information indicating a set of criteria for training or using a model associated with encoding uplink control channel data, wherein the set of criteria includes a criterion associated with an uplink control channel data distribution;
receive an indication that at least one criterion of the set of criteria is satisfied,
wherein the at least one criterion includes the criterion associated with the uplink control channel data distribution; and
transmit an inference configuration that includes a set of parameter values associated with the model.

9. The apparatus of claim 8, wherein the uplink control channel data distribution is a hybrid automatic repeat request acknowledgment (HARQ-ACK) data distribution.

10. The apparatus of claim 8, wherein the set of criteria is in at least one of system information, a radio resource control (RRC) message, a medium access control (MAC) control element (CE), or downlink control information (DCI).

11. The apparatus of claim 8, wherein the set of criteria includes at least one of:
a criterion associated with a physical position of the UE in a cell,
a criterion associated with a connection of the UE to one or more particular cells,
a criterion associated with a connection of the UE to one or more particular beams on a set of cells, or
a criterion associated with a configuration of a network entity.

12. A method of wireless communications by a user equipment (UE), comprising:
receiving, from a network entity, information indicating a set of criteria for training or using a model associated with encoding uplink control channel data, wherein the set of criteria includes a criterion associated with an uplink control channel data distribution; and
performing one or more operations associated with training or using the model based at least in part on a determination that at least one criterion, of the set of criteria, is satisfied,
wherein the at least one criterion includes the criterion associated with the uplink control channel data distribution.

13. The method of claim 12, wherein the uplink control channel data distribution is a hybrid automatic repeat request acknowledgment (HARQ-ACK) data distribution.

14. The method of claim 12, wherein the set of criteria is in at least one of system information, a radio resource control (RRC) message, a medium access control (MAC) control element (CE), or downlink control information (DCI).

15. The method of claim 12, wherein the set of criteria includes at least one of:
a criterion associated with a physical position of the UE in a cell,
a criterion associated with a connection of the UE to one or more particular cells,
a criterion associated with a connection of the UE to one or more particular beams on a set of cells, or
a criterion associated with a configuration of a network entity.

16. The method of claim 12, wherein performing the one or more operations comprises:
obtaining training data associated with training the model, and
transmitting the training data and an indication of the at least one criterion.

17. The method of claim 12, wherein performing the one or more operations comprises obtaining the model or a set of parameter values associated with the model.

18. The method of claim 12, further comprising:
transmitting an indication that the at least one criterion is satisfied, and
receiving an inference configuration that includes a set of parameter values associated with the model.
